(19) United States
(12) Patent Application Publication
(10) Pub. No.: US 2013/0024211 A1
(43) Pub. Date: Jan. 24, 2013

(54) ACTIVE LEARNING AND ADVANCED RELATIONSHIP MARKETING AND HEALTH INTERVENTIONS

(71) Applicants: Jeffrey J. Monteforte, Seven Hills, OH (US); Greg Muffler, North Royalton, OH (US); Dennis J. Gaukin, Broadview Heights, OH (US)

(72) Inventors: Jeffrey J. Monteforte, Seven Hills, OH (US); Greg Muffler, North Royalton, OH (US); Dennis J. Gaukin, Broadview Heights, OH (US)

(73) Assignee: ACCESS MOBILITY, INC., Cleveland, OH (US)

(21) Appl. No.: 13/631,167

(22) Filed: Sep. 28, 2012

Related U.S. Application Data
(63) Continuation-in-part of application No. 12/426,460, filed on Apr. 20, 2009.
Application No. 12/426,460 is a continuation-in-part of application No. 12/421,321, filed on Apr. 9, 2009.

(51) Int. Cl. G06Q 50/24

(52) U.S. Cl. 705/3

(57) ABSTRACT

Active learning and advanced relationship determination are employed with respect to a mobile marketing system and a mobile health notification system. A relationship between an advertiser and a consumer can become smarter over time as a function of interaction as well as non-interaction. Further, affinity groups or micro segments can be identified to aid tailoring of advertisements to consumers. Consumers can additionally be engaged in a dialog to acquire additional information and/or feedback data to develop a further understanding of specific consumers. Still further yet, assistance can be provided to advertisers so that advertisements can be customized for needs of potential customers. Similar learning concepts are applied to a mobile health notification system, wherein interactive wellness recommendations, prescription management alerts, and intervention encounters are delivered to a user based on a user's health profile.

### CROSS REFERENCE TO RELATED APPLICATIONS

This application is a continuation-in-part of application Ser. No. 12/426,460, filed Apr. 20, 2009, and entitled “ACTIVE LEARNING AND ADVANCED RELATIONSHIP MARKETING,” which is a continuation-in-part of application Ser. No. 12/421,321, filed Apr. 9, 2009, and entitled “CONTEXT BASED MOBILE MARKETING.” The entireties of these applications are incorporated herein by reference.

### BACKGROUND

Mobile devices continue to be wildly popular amongst most people. In the not so distant past, mobile devices where confined to bulky cell phones, pagers, and personal digital assistants (PDAs) utilized primarily for business purposes. Advances in technology and reductions in cost created much smaller and affordable devices, such that nowadays most everyone owns at least one mobile device. For instance, mobile phones, music players, and global positioning system (GPS) devices, gaming systems, and electronic book readers are increasingly pervasive. Furthermore, smart phones and other hybrid devices are becoming very popular since they provide a combination of functionality in a single device.

Marketing and more specifically advertising has changed over time with technology. At one time, television, radio, and mail were the primary means for advertising. Accordingly, advertising was accomplished by way of commercials and direct mailings. With the advent of the Internet, advertisers were afforded additional dissemination mechanisms including e-mail and search. Consequently, advertisements are now also provided in the form of or within e-mail, embedded with Web pages, and proximate to or as search results, among other things. The proliferation of mobile devices now provides advertisers with yet another way to reach potential customers. Further yet, advertisers are now seeking to exploit location information enabled by many mobile devices. Such functionality is often referred to as a location-based service (LBS) or alternatively location-based advertising (LBA). Location-based services supply information as a function of the geographical position of a mobile device. One or more location mechanisms can be utilized by such services including GPS, triangulation, and local proximity technologies such as Bluetooth, infrared, wireless local areal network (WLAN), and radio frequency identification (RFID), among other things. Applications can then utilize the determined location to aid navigation or focus search results. Moreover and as previously mentioned, advertisements or the like can be transmitted to users based on their location as determined via their mobile device. For example, when a mobile phone is determined to be within a specified distance of a restaurant, a text message can be sent to the user including a promotional code associated with some discount, such as 10% off a meal or a free appetizer with the purchase of two entrees.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, one or more embodiments of the subject disclosure pertain generally to active learning and advanced relationship marketing in the context of a marketing system or service. Here, mechanisms are provided for engaging consumers in an ongoing dialog with a mobile marketing system or service to collect pertinent information. Dialog information amongst other acquired information such as transactional activity can be utilized to form a learning relationship between a consumer and advertiser that develops and changes over time with every interaction as well as non-interaction. Consequently, advertisements can be increasingly tailored and consumers are more precisely differentiated.

In accordance with a particular aspect of the disclosure, affinity groups or the like can be formed, and consumers can be moved into or out of groups as a function of newly acquired information, for instance. Predictions about what a consumer is likely to need or desire can then be made based on group membership. In this manner, an advertisement can be identified and provided to a consumer based on a likely need or desire of which the consumer is not yet aware.

According to yet another aspect, advertisement assistance can be provided with respect to generating precisely targeted advertisements based at least in part upon a vast collection of knowledge acquired. By way of example and not limitation, recommendations can be made to advertisers upon detection of an unmet need or desire to facilitate generation of an advertisement that addresses the need or desire. Additionally, concept testing can be performed and advertiser questions answered.

In other aspects, one or more of the active learning and relationship development features described above can be employed in a web-based health and wellness system that provides users with personalized, context-specific health management information. The health and wellness system can correlate personal health information (e.g., medical records, known medical conditions, drug prescriptions, etc.), medical database information, and environmental context information to provide timely medical intervention information to the user. For example, the health and wellness system can dynamically modify the user's medication schedule based on information regarding active prescriptions, known medical conditions, current environmental information, and other such information, and provide medication reminders to the user's personal device based on the managed medication schedule. The health and wellness system can also supplement doctors' prescribed health regimens by providing personalized, proactive health recommendations based on a user's personal information, medical history, and determined health risks associated with the user's known conditions.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a mobile marketing support system in accordance with an aspect of the disclosed subject matter.

FIG. 2 is a block diagram of a representative dialog component according to a disclosed aspect.

FIG. 3 is a block diagram of a representative analysis component in accordance with an aspect of the disclosure.

FIG. 4 is a graphical illustration of predictive analysis according to a disclosed aspect.

FIG. 5 is a block diagram of a representative advertisement component in accordance with an aspect of the disclosure.

FIG. 6 is a block diagram of a mobile marketing system in accordance with an aspect of the subject disclosure.

FIG. 7 is an exemplary environment in which the mobile marketing system of FIG. 6 can be employed according to an aspect of the disclosure.

FIG. 8 is a block diagram of a representative context component in accordance with a disclosed aspect.

FIG. 9 is a block diagram of a representative consumer interface component according to a disclosed aspect.

FIG. 10 is a block diagram of a representative advertiser interface component in accordance with an aspect of the disclosure.

FIG. 11 is a block diagram of a representative correlation component in accordance with an aspect of the disclosed subject matter.

FIG. 12 is a block diagram of a representative delivery component according to a disclosed aspect.

FIG. 13 is a block diagram of a representative consumer interface component according to a disclosed aspect.

FIG. 14 is a flow chart diagram of a method of actively collecting information from users according to an aspect of the disclosure.

FIG. 15 is a flow chart diagram of a method data analysis in accordance with a disclosed aspect.

FIG. 16 is a flow chart diagram of a data analysis method according to an aspect of the disclosure.

FIG. 17 is a flow chart diagram of a method of assisting an advertiser in advertisement generation in accordance with a disclosed aspect.

FIG. 18 is a flow chart diagram of a method of concept testing in accordance with an aspect of the disclosure.

FIG. 19 is a flow chart diagram of a method of advertiser inquiry according to a disclosed aspect.

FIG. 20 is a flow chart diagram of a method of mobile advertisement in accordance with an aspect of the disclosure.

FIG. 21 is a flow chart diagram of a method of employing advertisements in accordance with a disclosed aspect.

FIG. 22 is a flow chart diagram of a method of offer redemption in accordance with a disclosed aspect.

FIG. 23 is a flow chart diagram of a method of advertising as a function of calendar entries according to a disclosed aspect.

FIG. 24 is a flow chart diagram of a method of advertisement distribution according to an aspect of the disclosure.

FIG. 25 is a flow chart diagram of a method of advertising based on behavior model according to a disclosed aspect.

FIG. 26 is a flow chart diagram of a method of group advertising in accordance with an aspect of the disclosed subject matter.

FIG. 27 is an exemplary environment in which a health and wellness system can be employed.

FIG. 28 is a block diagram of an exemplary health and wellness system configured to provide wellness recommendations according to one or more aspects.

FIG. 29 is a block diagram of an exemplary health and wellness system configured to assist users with managing their prescription medications.

FIG. 30 is a block diagram of an exemplary health and wellness system configured to provide intervention encounter notifications based on a user's medical and physical conditions.

FIG. 31 is a flow chart diagram of an exemplary methodology for providing context-specific wellness recommendations to users with existing medical conditions.

FIG. 32 is a flow chart diagram of an exemplary methodology for assisting a user to manage a medication prescription.

FIG. 33 is a schematic block diagram illustrating a suitable operating environment for aspects of the subject disclosure.

FIG. 34 is a schematic block diagram illustrating a suitable operating environment for aspects of the subject disclosure.

FIG. 35 is a schematic block diagram of a sample-computing environment.

### DETAILED DESCRIPTION

Systems and methods pertaining to active learning and advanced relationship marketing described in detail hereinafter. Feedback and customization capabilities make it possible to provide a bridge for advertisers to interact with potential consumers. Feedback or other information can be actively collected from consumers by engaging them in a dialog that is designed to extract pertinent information. Such dialog information in conjunction with other information such as transactional activity can produce a learning relationship between advertisers and consumers that can change over time as a function of interaction as well as non-interaction, among other things. This relationship learning capability enables advertisements to be increasingly tailored and a consumer more precisely differentiated from other consumers. Furthermore, a variety of analytics can be executed with respect to acquired data. For instance, affinity groups or the like can be generated and employed to make predictions about consumer needs or desires. Still further yet, collected or learned information can be utilized to assist advertisers in generating precisely targeted advertisement that produce unprecedented levels of response and return on investment while also improving customer loyalty.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

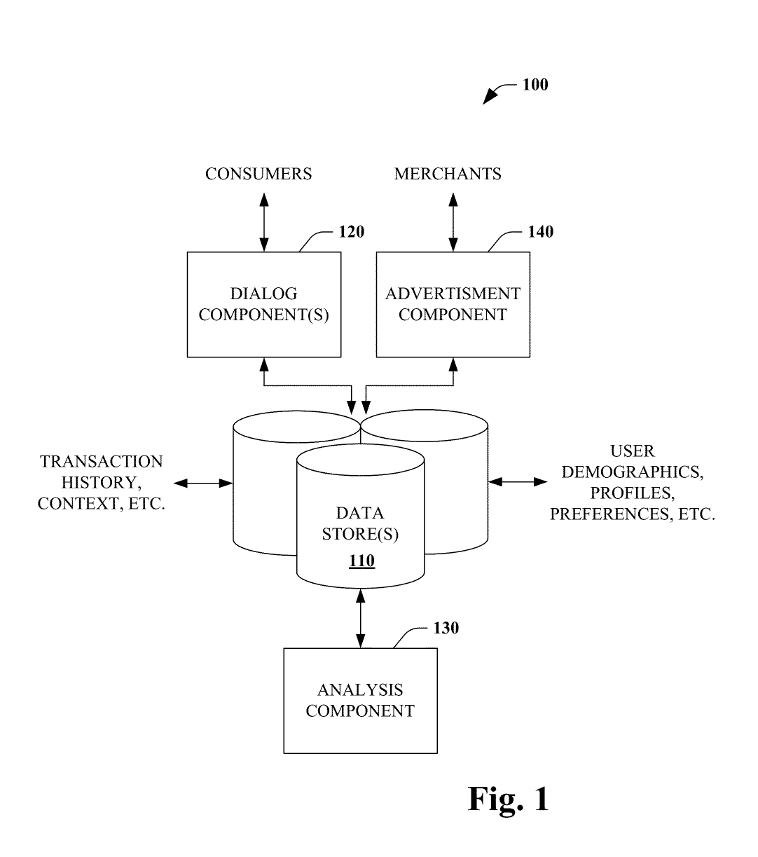

Referring initially to FIG. 1, a mobile marketing support system 100 is illustrated in accordance with an aspect of the claimed subject matter. In particular, the system 100 includes one or more data stores 110 that house advertiser and user or consumer information, among other things. For example, such information can include, without limitation, demographic information, context information (e.g., location, extrinsic data . . . ), transaction history, and/or personal health data. The information can be acquired by an associated system, component thereof or a third-party service. Furthermore, information can be produced as a function of other information or data. As will be described in further detail infra, information persisted to one or more data stores 110 can be employed to facilitate matching of advertisements to users with respect to a mobile marketing system.

The system 100 can also include one or more dialog components 120 (e.g., online, mobile device . . . ) communicatively coupled with data store(s) 110. A dialog component 120 engages a user or consumer in a dialog to acquire pertinent information that can aid a mobile marketing system. More specifically, the dialog component 120 can acquire additional information, or feedback, from users including, without limitation, opinions, attitudes, likes, dislikes, and preferences. Further, feedback can be specified with respect to a mobile marketing system, an advertiser, an advertisement, and/or a product or service, among other things. While a user can explicitly enter information such as a profile, preferences, or settings, for example upon mobile marketing system setup, the dialog component 120 allows information to be continually collected, for example upon naturally occurring events, among other things. Furthermore, it should be appreciated that such customer feedback data can be integrated with transaction data and member profile and preference information to facilitate predictive analytics so that a resulting analysis include a complete understanding of member preferences, motivations, and intentions, as will be described further infra.

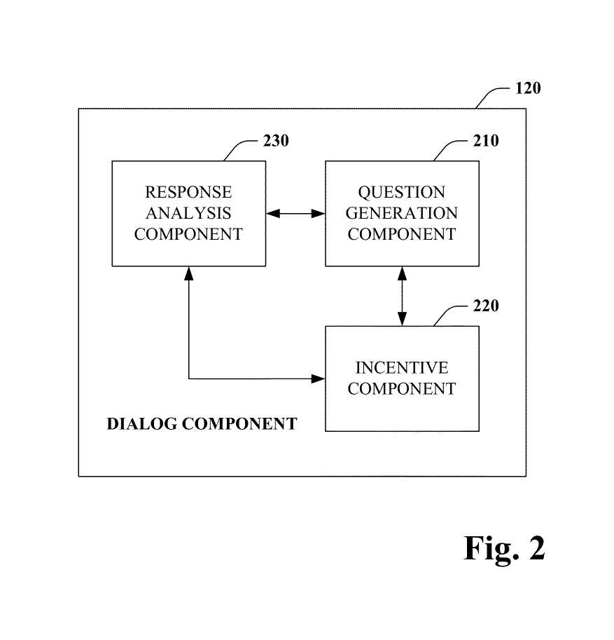

Turning attention to FIG. 2, a representative dialog component 120 is depicted in accordance with an aspect of the claimed subject matter. As shown, the dialog component 120 includes a question generation component 210, an incentive component 220, and a response analysis component 230.

The question generation component 210 generates or otherwise acquires questions for presentation to a user. For example, such a question could be “On a scale of 1-5, how would you rate your experience with a particular retailer?” or “How would you rate a provided offer?” In another embodiment, the question generation component 210 can produce a rating bar or like response tactic that can be employed to allow members to indicate their personal attitude, opinion, and/or satisfaction with an item, among other things. The rating bar tactic can use a displayed continue or next button that is represented by a continuous scale of colors, progressing from green to red. This provides a richness of feedback without adding complexity to the user interface or interaction process.

The incentive component 220 can provide one or more mechanisms that encourage a user to participate in a dialog or to converse with a marketing system. A modest incentive can increase response rates dramatically. For instance, at a restaurant, a user can be asked to rate the food and/or service, and to encourage a response the incentive component 220 can offer a coupon to the user for a discount off the bill. In another instance, a user can be entered into a drawing for something such as a gift card, a car, or a vacation package. In this manner, a user can be encouraged to answer more than a current set of questions. Rather, the user is encouraged to continue dialog to increase the chances of winning some prize.

Of course, various other incentives or rewards can be employed to encourage user participation or investing in a relationship with a mobile marketing system. By way of example and not limitation, the incentive component 220 can also provide game functionality to motivate users to engage in a dialog. As an example, a user may earn points for responding to inquires and users can strive to obtain a high score. Users can also be pitted against one another to compete for the best score, wherein the users are motivated by pride and/or a particular prize.

Further yet and in accordance with one embodiment, the incentive component 220 can ensure that incentives do not introduce respondent bias, where some members become more likely to respond than others do. The secret is to offer an incentive with universal appeal that all members may find equally attractive. Typical universally desired incentives include, without limitation, 1) entry into a prize drawing for an item or a cash prize; 2) award of points in a Rewards Program where the points can be redeemed for a promotional item with a mobile marketing system corporate logo, which not only encourages participation but also has a marketing and brand awareness advantage; 3) access to a small digital download, such as a ringtone, mobile video game or song; and 4) recognition in a “Members of the Week” section program. Additionally, when people feel they have an important stake in the types and quality of service offered they will often participate simply because it is in their own long-term best interest.

The response analysis component 230 can receive, retrieve or otherwise obtain or acquire a response to a question as well as analyze that response. For example, the component 230 can determine whether the response is valid, acceptable, and/or appropriate. Furthermore, the response analysis component 230 can work together with the question generation component 210 to enable intelligent follow-up questions to be asked and/or modification of the form of a question, for instance as a function of responses. Among other things, this enables more open-ended questions to be presented to a user, since the response analysis component 230 can interpret any response rather than simple scalar ratings. By way of example, consider gathering of feedback information about an offer. After a user has rated an offer, a subsequent question can be sent to the user concerning what the user liked or disliked about the offer based on the rating. Further, the user can be asked how the offer could be modified to make it more appealing to them or the like. It is also to be noted that the response analysis component 230 can be coupled to the incentive component to ensure that incentives are provided for responses or particular types of responses.

It is to be appreciated that the dialog component 120 or subcomponents thereof can be context aware. Accordingly, dialog can further utilize contextual information with respect question generation and the like. By way of example, the dialog component 120 can detect or infer a device that a user is employing and control the type or style of inquiry. For instance, where the device is a mobile device such as a phone, the dialog component 120 can utilize seek to acquire small discrete pieces of information utilizing one-off questions like rankings (e.g., rate experience on a scale of 1-10). Alternatively, if a user is employing a desktop computer or laptop a much more robust conversation can be initiated. For example, a survey or the like can be designed to build a robust three hundred and sixty degree view of the user.

However, accordingly to one embodiment, surveys can incorporate a 5-point Likert scale (or “category identifier”) with a representative scale of: (5) Very satisfied, (4) Somewhat satisfied, (3) Neither satisfied nor dissatisfied, (2) Somewhat dissatisfied, (1) Very dissatisfied. Key features of this scale are that it is symmetrical and avoids descriptors with strong emotional connotations. A similar scale will be utilized to measure agreement with certain statements or likelihood to take certain future behaviors.

Additionally, contextual information can be employed to control the timing of requests for feedback. Properly timed customer satisfaction surveys ratings or the like will obtain additional, valuable topics of interest to advertisers including, quality of customer service, pricing versus competitors, product-level satisfaction, likelihood to recommend, and likelihood to repurchase. Generally, member inquires can be conducted frequently enough to keep a “pulse” on member sentiments, thus allowing a mobile marketing system to make improvements to processes on a continual basis. For example, a survey can be conducted at a particular time after a specified promotion or marketing campaign, while the experience is still fresh on consumers' minds. In other words, questions can be asked on, after or during naturally occurring events, among other things.

Furthermore, context information can be associated with questions and answers such that preferences, opinions or the like can be context dependent. For instance, it can be determined or inferred from dialog with a user, that when a user is at home on Sundays, he/she prefers Italian food when the temperature is below fifty degrees Fahrenheit; otherwise, he/she has a preference for grilled food.

Overall, it is to be appreciated that the dialog component 120 can provide a natural, non-threatening, and even encouraging mechanism for conducting an ongoing, deep, and rich dialogue with consumers. Further, users or consumers can help a mobile marketing system, along with its advertisers, target new system members and prospects, among others. Beginning with standard market research, available for purchase to most firms, allows a mobile marketing system to determine member groupings by demographic and psychographic characteristics, among other things. However, this level of analysis does not allow a promotional offer to be customized to match the requirements of a micro-segment or an individual. In order to create a learning relationship, a continuous feedback link and dialogue between a mobile marketing system and its members can be established.

Electronic channels, such as email, web site, and online surveys are at a system's disposal to invite dialogue from its members. In addition, emerging mobile technology advancements can be imbedded into a delivery channel that can take advantage of GPS location tracking and mobile interactions and replies, to continually poll members for essential, yet discrete pieces of data and feedback. These dialogue channels are preferred because of their inherently low cost and increased response capability. For example, a standard approach for obtaining customer preferences by manufacturers is the use of warranty cards. In truth, the production of warranty cards, their inclusion in product packaging and the cost of prepaid postage causes the use of warranty cards to greatly exceed the described alternative approaches. Moreover, the number of customers who actually return warranty cards is typically less than ten percent—far below the anticipated response rate of dialogue contacts.

Stated differently, in today's “connected” society better response rates are typically associated with online surveys rather than paper surveys thanks to strong Internet penetration and technically savvy users. Respondents usually prefer the online format due to convenience, ease of survey completion, and lower time requirements. As for the actual boost expected from the dialogue approach, for response rate going from paper to online, the boost depends on the target audience. For example, because of their high propensity to using the online channel, if 18-26 year old males are surveyed, it is expected that a much larger boost would be seen than if the elderly were surveyed.

Although preferred, the claimed subject matter is not limited to an online format. In fact, paper surveys can be mailed to those users that prefer such interaction. Subsequently, such information can be entered or scanned into the system and associated with the particular user who completed the survey.

Motivating users or members to complete an online customer survey is always a challenge, but various best practices as well as innovative and contemporary methods can be employed to improve survey response rates dramatically. For instance, to encourage a maximized survey response rate, three main factors can be considered, namely, survey length, incentives, and communications.

There is a strong inverse relationship between survey length and response rates. Accordingly, short, but more frequent, feedback and survey techniques can be utilized. For example, member feedback and survey initiatives can be limited to no more than ten questions in length, when performed online and no more than three questions when performed on a mobile device. This policy of survey length translates into an average of about one to two minutes of member time. However, that assumes a variety of different question formats dealing with separate aspects of the customer experience, but if the questions are all in a similar format and can be completed more quickly a longer questionnaire can be employed. Of utmost importance is survey completion time.

Furthermore, it should be appreciated that to encourage more detailed survey responses, open-ended survey questions should be worded properly. For example, it is better to ask, “What are three ways that Company XYZ can serve you better?” than “How can Company XYZ serve you better?”

To achieve statistically valid results, the system dialog component can strive to achieve a statistically significant sample of n=400 completed surveys for online market research surveys. This will provide statistical validity at the 95% confidence level with +/−5% confidence interval. Initially, when the member base is small, a sample of n=200 completed surveys can be utilized, which provides statistical validity at the 95% confidence level with +/−7% confidence interval.

The dialog component 120 can also ensure proper-targeted respondent sampling. Panels of survey respondents can be identified and utilized that closely mirror the United States population in terms of gender, region, race, and household income per the latest US Census data. If requested by an advertiser, the dialog component 120 can generate a sample targeted at a particular demographic or behavioral subgroup. Accordingly, a guarantee can be made to advertisers that all survey quotas will be met at a fixed cost per completed survey.

There has been an observed response bias in customer satisfaction surveys towards the customers on either extreme of the satisfaction scale, particularly those who are very dissatisfied. In other words, very satisfied or dissatisfied customers are more likely to respond to a survey invitation than those more towards the middle. Sampling and survey administering tactics can combat the resulting “polarization” of customer survey data by assuring the maximum survey response rate possible, thus capturing more of the ambivalent customers and making the customer survey responses more representative of the overall customer base.

Further still, since a mobile marketing system is transactional in natured, the dialog component 120 can make use of a perpetual survey in one embodiment where respondents are asked to complete the survey immediately after a transaction. Regardless of survey administration frequency, a single respondent should not be asked to participate more than once a week, for example, to avoid respondent fatigue.

Returning briefly to FIG. 1, the marketing support system 100 includes an analysis component 130 communicatively coupled to the data store(s) 110. The analysis component 130 can execute various analytics or logic over various data including consumer profiles, preferences, and purchasing behavior to help advertisers drive highly targeted and effective advertisement campaigns and provide consumers with precisely tailored advertisements. Although not limited thereto, in one embodiment, the analysis component 130 can identify community likeness, affinity grouping, and/or market or micro segmenting.

A cornerstone of the desired learning relationship is having members that teach the marketing system about their specific needs. In other words, the system does not solely rely on information about the member (e.g., purchased demographic data) but on information from members. This insight enables the marketing system to convert a sale from a one-time event into a continuous iterative process.

A significant long-term advantage for the subject marketing system is not competing on the size of membership base but on the scope of the relationship maintained with an individual member. In a battle for building loyal, repeat members with significant lifetime value (LTV), the successful mobile marketing system will not be the one with the most members, but the one with the most knowledge about individuals' wants and preferences.

By integrating community likeness analysis, the marketing system will be in a position to anticipate what a particular member wants, even before she realizes she wants it. Community likeness analysis is enabled by accumulating information about the whole community of members' tastes, needs, and preferences.

The power of community likeness is considerably leveraged when a member requests something significantly different from what is in the member's previously accumulated profile and behavior pattern. Specifically, this aspect will alert the member that this is a new aspect of her behavior that has been learned or inferred. The member's information can then be automatically updated and/or updated with approval by clicking on a link, for example. In one instance, this can arise when the member has performed a search across all offers and has activated an offer that was not sent to her because it did not satisfy the member's current profile and preference settings. Additionally or alternatively, the analysis component 130 can perform predictive analysis in a further attempt to obtain a complete understanding of members.

In essence, members can be provided with a proactive marketing agent that acts in the best interest of the member by leading the member to an offer for a product that has been determined or inferred to be likely of need to the member, while the member is unaware of this need. For example, if over seventy percent of the member's community (e.g., members who spend a significant amount of time in their cars, because of work related sales activity) purchased an in-car power cord for a newly released cell phone, then there is a high propensity that this member will also have a need for the in-car power cord—if she only knew that it was not included with the purchase of the phone and that there was an active offer for the product.

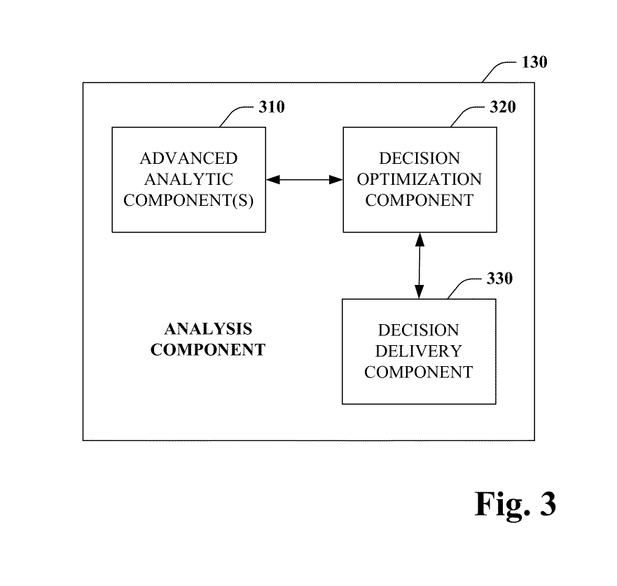

Turning attention to FIG. 3, a representative analysis component 130 is illustrated in accordance with an aspect of the claimed subject matter. Overall, the analysis component 130 can seek to provide actionable data that facilitates highly tailored and precise advertisement matching. In furtherance thereof, the analysis component 130 includes advanced analytic component(s) 310, decision optimization component 320, and decision delivery component 330. The advanced analytic component(s) 310 execute statistical, mathematical, and/or other algorithmic techniques that are used to examine the way in which specific issues relate to data on past, present, and future actions. The decision optimization component 320 analyzes actions to determine which actions will drive optimal outcomes. These “optimal actions” are delivered by the decision delivery component 330 to particular individuals, entities, systems, or the like that can perform the actions. In other words, the analysis component 130 can engage in predictive analysis to among other things reduce marketing costs, improve marketing return on investment, improve customer loyalty, and provide customer intimacy.

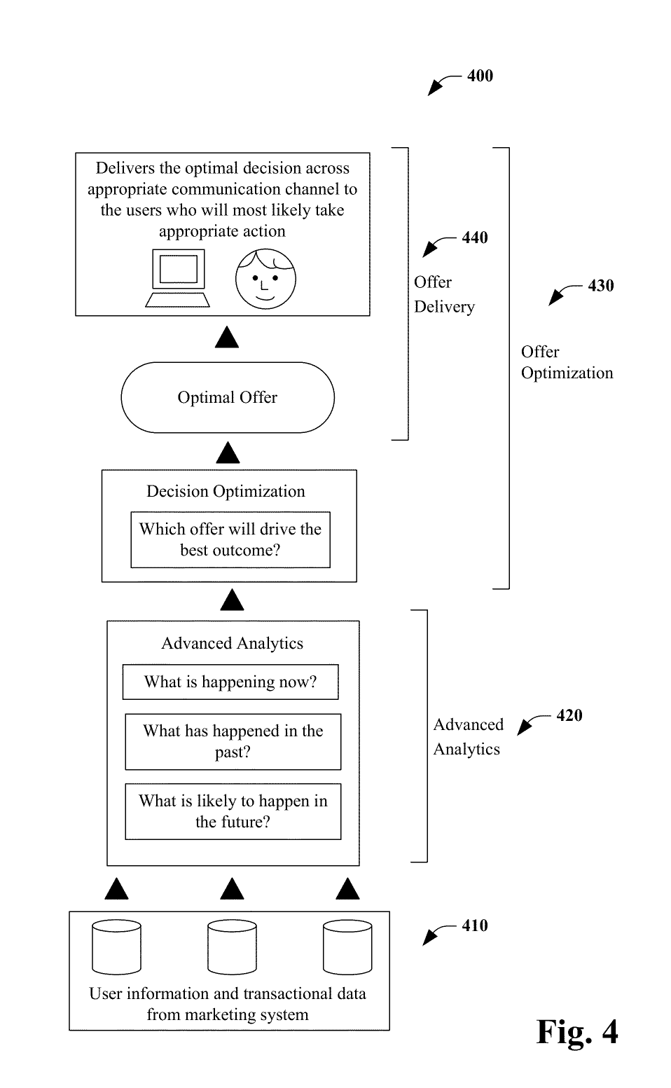

FIG. 4 provides a graphic illustration 400 of employment of predictive analysis in accordance with an aspect of the claimed subject matter Information from the marketing system 410 can be analyzed utilizing advanced analytics 420. In particular, what is happening now, what as happened in the past and what is likely to happen in the future is determined and/or inferred from user information and transactional data from the marketing system, among other things. For example, it can be determined that it is a warm summer morning and a user is in the proximity of a coffee shop. In similar circumstances in the past, the user has purchased an ice coffee. Accordingly, it can be predicted that the user might again like to purchase an iced coffee. Offer optimization 430 can then be performed to determine the specifics to an offer that will drive the best outcome. In the ongoing example, providing a user with an advertisement alone or in conjunction with a discount offer would drive the outcome of encouraging a purchase. Offer delivery 440 can subsequently deliver the advertisement across appropriate channels to particular users who will most likely perform a desired action.

Of course, this is an over simplified example of the capabilities of predictive analysis meant solely to aid in understanding. The predictive analysis can perform much more sophisticated operations, for example to identify seemingly unconnected items to a user. For instance, it may be determined that an iced coffee drinker is likely to have an interested in a particular pastry or book. The predictive analysis can thus identify an anticipated need or desire of which a consumer is unaware. Furthermore, as will be described below, the predictive analysis can aid advertising campaign recommendation and answering of business questions particular questions.

Returning briefly to FIG. 1, the support system 100 also includes an advertisement component 140 communicatively coupled with the data store(s) to help advertisers produce effective advertising campaigns. More specifically, the advertisement component 140 can employ information or data housed in the data store(s) 110 to provide advertisers valuable insight into the needs of potential consumers and help advertisers avoid costly mistakes such as by introducing a new line of goods or developing a costly marketing campaign that no one really wants.

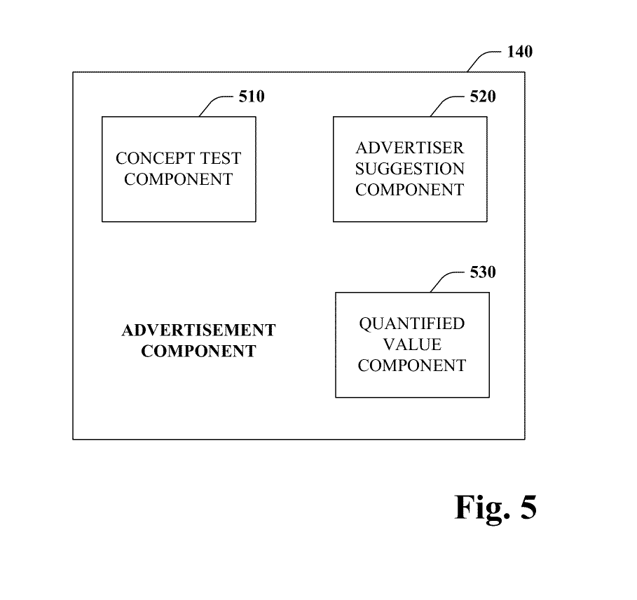

Referring to FIG. 5, a representative advertisement component 140 is shown according to an aspect of the claimed subject matter. The advertisement component 140 includes a concept test component 510 that facilitates testing of advertisements. Rather than simply designing an advertisement or advertising campaign and implementing it, the advertisement can first be tested. More specifically, and as will be described further with respect to a particular marketing system, the advertisement and profile associated therewith, for example, can be input into the system and matching users can be identified without actually providing the advertisement to the user. In this manner, the actual number of users that will receive this ad can be known. An advertiser can further alter an advertisement and a profile and/or settings associated with the advertisement and retest the advertisement. A cycle of advertisement modification and testing can continue until an advertiser is satisfied.

The advertisement component 140 can also include an advertiser suggestion component 140 that, among other things, provides suggestions or recommendations to an advertiser with respect to advertisement creation. The advertiser suggestion component 520 can analyze a plurality of data (e.g., profiles, preferences . . . ) stored with respect to numerous consumers and indentifies where no match is being made. Stated differently, the component 520 can identify where there is a need or desire that is not being met. Once identified, the advertiser can be notified via suggestion or recommendation. In particular, the advertiser can be informed that if a particular advertisement is pushed out, it will reach a specific number of potential consumers. It is an advertisement or offer that the advertiser is not contemplating but of which a high push, conversion, and/or redemption rate can be guaranteed. Furthermore, if sufficient information is provided, the advertiser suggestion component 520 can automatically generate an advertisement, promotional offer of the like for presentation to the advertiser. Upon permission, the advertisement can be activated and pushed to potential consumers. Further yet, the advertiser can simply authorize pushing automatically generated advertisements to users within particular parameters (e.g., discount amount, product category . . . ) without additional confirmation.

Quantified value component 530 is also part of the advertisement component 140 to further aid provisioning of information to advertisers. In particular, the quantified value component 530 can analyze collected market data and provide quantified values for example in reports. The subject marketing support system seeks to receive, retrieve or otherwise obtain or acquire a substantial amount of information to aid in precisely tailoring advertisements to users as well as improving target advertising campaigns. In one instance, an advertiser can subscribe to a service from which reports can be generated and provided thereto to help them understand the current state of a market including perhaps the effectiveness and/or ineffectiveness of other advertiser's advertisement campaigns. Information can also be aggregated and presented to a user in a variety of manners to facilitate comprehension. Still further yet, the quantified value component 530 can answer specific advertiser questions as a function of collected data. For example, a question can pertain to the number of women over 35 in a particular area that have been responsive to offers for discounted salon products, and the quantified value component 530 can provide a numerical response to this query.

In accordance with one embodiment the quantified value component 530 can produce a market assessment designed to form a snapshot of a target market in terms of demographics (e.g., age, gender, income . . . ), psychographics (e.g., hobbies, interests, wants, needs, fears, aspirations . . . ) and behaviors (e.g., where they shop, when they shop, how often they go out, when they want to receive offers, how much money they spend . . . ). Once such information has been collected, advertisers have ample data to estimate response and return on investment of a potential advertisement.

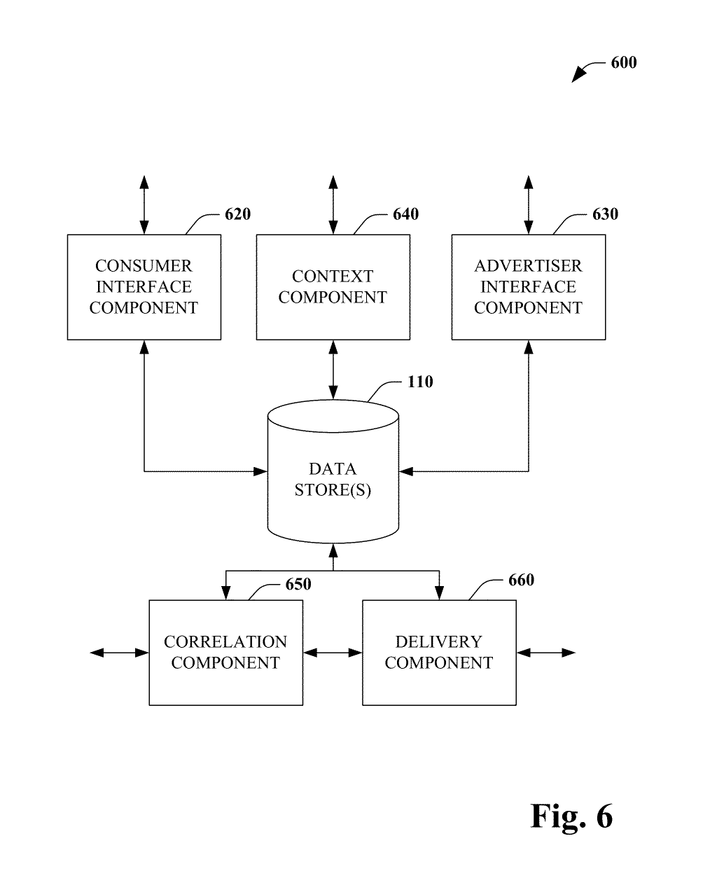

Turning attention now to FIG. 6, a mobile marketing system 600 within which aspects of the support system 100 of FIG. 1 can be employed in accordance with an aspect of the claimed subject matter. The system 600 includes one or more data stores 110 that house data pertaining to at least advertisers and consumers. The number, type, and configuration of data stores can vary. For example, the data store(s) 110 can be embodied as one or more database and data warehouse systems. Consumer interface component 620, advertiser interface 630, and context component 640 are communicatively coupled to the data store(s) 110 and provision different types of data for storage and subsequent employment to facilitate correlation and delivery of advertisements.

The consumer interface component 620 is a mechanism that facilitates collection of consumer or system user information. The extent of such information can vary but in general concerns at least identification of a user and a means for receiving advertisements. For example, a consumer can provide his/her name and specify a mobile computing device such as a mobile phone to receive advertisements. The consumer interface can also collect profile and/or preference information. A profile can include among other things, address, date of birth, gender, profession, income, ethnicity, religion, and/or group memberships. User preferences or settings can include, without limitation, categories of products/services of interest, companies of interest, keywords, advertisement delivery schedule (e.g., days of week, time of day . . . ), and means of notification and/or delivery (e.g., text message, email, local application . . . ). Alone or in combination, the user profile and/or preferences can act as advertisement filters for matching advertisements, as will be described further infra.

The advertiser interface component 630 is a mechanism that aids retrieval of advertiser related information such as advertiser or company, and advertisement or advertisement campaign information, among other things. For example, information can be collected regarding the location and/or particular stores for which advertisements or more specifically promotional offers will be valid. Further, advertisement interface component 630 can facilitate construction of a promotion and specification or particular preferences to control distribution such as category, keywords, and age range. Specifics regarding the promotion can also be acquired including when the advertisement will be sent and the total number of advertisements to be sent or variations thereof (e.g., impressions, views, activations . . . ). Such information can also be referred to as an advertisement or offer profile.

The context component 640 acquires and contributes context information to the data store(s) 110. Context relates generally to conditions that occur surrounding a consumer and/or advertiser, among other things. As will be discussed, further below, context can include, without limitation, user location information, and other extrinsic data. As will further be appreciated in light of later discussion, context provides yet another factor that can be considered when determining whether or not to provide a particular advertisement to a user.

The system 600 also includes correlation component 650 communicatively coupled to the data store(s) 110. The correlation component 650 can acquire data/information at least from the data store(s) 110 for use in correlating or matching advertisements to particular users. Matching can range from relatively simple to quite complex. For example, matching can be accomplished by determining whether or not a consumer and advertiser filters match. Additionally or alternatively, the correlation component 650 can engage in a more predictive assessment, for instance, where it infers matches as a function of a collection of information for which filters or preferences have not be explicitly identified. In one particular embodiment, the correlation component 650 can make predictions based on community likeness or affinity groups in which a user is deemed a member.

Delivery component 660 is communicatively coupled to the correlation component 650 as well as the data store(s) 110. Upon receipt or retrieval of matching advertisements from the correlation component 650, the delivery component 660 can deliver the advertisement or advertisement related information to a user by way of some computing device associated with the user. By way of example and not limitation, the delivery component 660 can send a text message (e.g., Short Message Service (SMS) communication), multimedia message (Multimedia Messaging Service (MMS) communication), e-mail (electronic mail), or an application message including the advertisement and/or information pertaining to the advertisement.

Further, the delivery component 660 can utilize information from the data store(s) 110 to determine if, when, and/or to which device the advertisement is sent. For example, a user may set preferences that dictate delivery. Additionally or alternatively, the delivery component 660 can determine or infer delivery specifics based on context information. For instance, if it can be determined that a user is likely skiing down a slope based on temperature, weather conditions, altimeter, and accelerometer data, the delivery component 660 would probably wait to transmit the advertisement until he/she is in line at a lift or in lodge café. Furthermore, where a user employs more than one device capable of receiving advertisements the delivery component 660 can also determine or infer to which device a user would prefer to receive an advertisement and send it to that device.

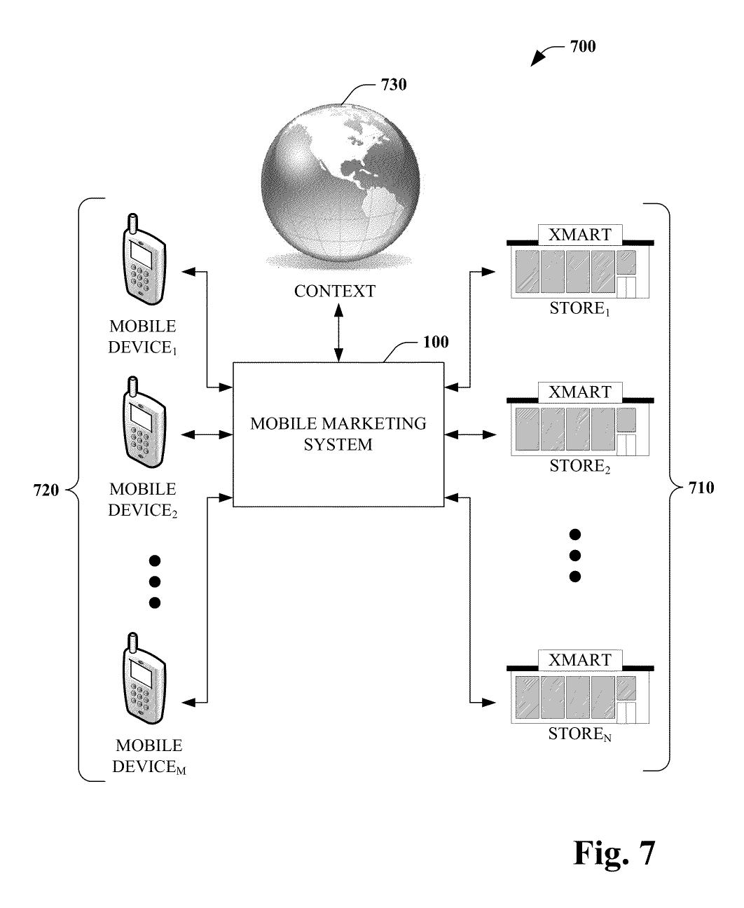

FIG. 7 depicts an exemplary environment 700 in which the mobile marketing system 100 can be utilized. In particular, the mobile marketing system 100 is positioned between a plurality of merchants or stores 710 (STORE₁-STORE_{N}, where N is greater than or equal to one) and mobile devices 720 (MOBILE DEVICE₁-MOBILE DEVICE_{M}, where M is greater than or equal to one). The stores 710 can be traditional physical stores and/or online stores. Further, it should be noted that one or more stores 710 could correspond to the same store yet in a different location such as the case in chain or franchise stores. The mobile devices 720 can correspond to any computing device that is able to receive an advertisement. For example, a mobile device can be embodied as a mobile phone, a palmtop computer, a personal digital assistant (PDA), a music player, a GPS receiver, or an electronic book reader, among other things. Where a device cannot acquire such a message directly over some communication framework (e.g., cellular phone, Internet . . . ), it can be afforded indirectly by way of some other device (e.g., Bluetooth, wired connection . . . ). Furthermore, it should be noted that although described as mobile, such device 720 is not so limited and as such can also be substantially immobile. In addition to information provided by stores 710 and mobile devices 720, the mobile marketing system 100 can also acquire contextual information or context 730 from some other device (e.g., car, appliance . . . ), place, location, or supplier.

The environment 700 is provided to facilitate clarity and understanding with respect to aspects of the claimed subject matter. As shown, the mobile marketing system 100 is positioned between the stores 710 and mobile devices 720. This position is conceptually significant. In one embodiment, the mobile marketing system can be employed by one store and one or more devices 720. In this situation, the mobile marketing system 100 has access to a plurality of users and information regarding their interaction with the sole store 710. However, where multiple stores 210 are employed in conjunction with multiple mobile devices 720, the mobile marketing system 100 acquires information about numerous users and their interactions with a plethora of stores. In this scenario, this information gain is beneficial to both users and stores. For example, information about advertisements provided to and/or offers redeemed by users from multiple stores can be utilized to further refine correlation to provide more users with more relevant advertisements advertisers with more effective campaigns. Further, such information can be fed back to advertisers to allow them to readjust or retarget advertisement campaigns,

More specifically, a consumer's mobile device 720 can be electronically linked to a mobile marketing system database. This link, over time, can provide discrete snapshots of transactional interaction data that illustrate how the consumer responds to an advertisement. Advertisement details such as specific product or service, type and size of discount, how quickly an offer is activated, where the consumer was traveling and other significant time-location based aspects can be collected. A consumer's experience can be associated with the transactional interaction data producing a three hundred and sixty degree view of the consumer's behavior. Still further yet, each consumer's transactional interaction data or transactional exhaust can be leveraged to aid target advertisement generation and advertisement correlation, for example based on affinity groups or the like.

It is to be appreciated that while the mobile marketing system 100 can reside between stores 710 and devices 720, implementations of the system need not provide such distinct separation. By way of example and not limitation, at least a portion of the mobile marketing system functionality can be resident on mobile devices 720. For instance, a mobile device 720 can include an application executed thereon that communicates with an external server as needed. The functional split can also be adjusted as a function of capabilities (e.g., dumb vs. smart device) and substantially in real-time based on device and/or server load or failure, among other things.

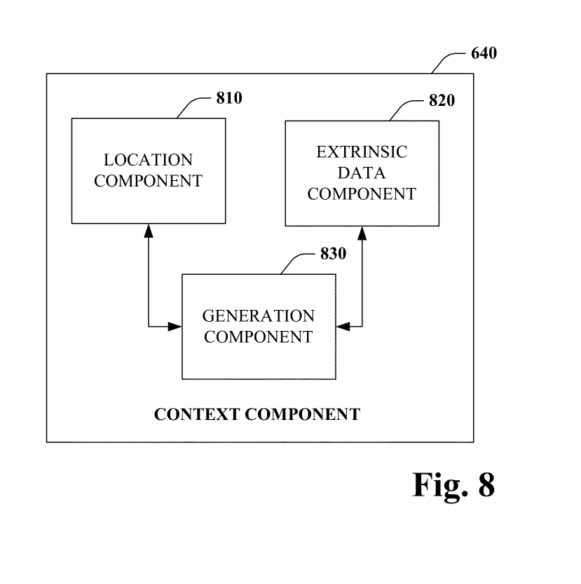

Turning attention to FIG. 8, a representative context component 640 is illustrated in accordance with an aspect of the claimed subject matter. As previously mentioned, the context component 640 facilitates collection of information regarding conditions surrounding a consumer and/or advertiser, among other things. One such piece of information is user and advertiser location, which can be acquired by location component 810. Location can be obtained in a variety of manners. For example, the location component 810 can collect this information from a user (e.g., city, state, zip code . . . ). Additionally or alternatively, location information can be acquired from a mobile computing device. For example, a device GPS receiver and/or wireless communication (e.g., cellular triangulation, IP address location . . . ) can be employed to identify location of which location component 810 can receive or retrieve. The location component 810 can also acquire location information from third party services and/or devices (e.g., mobile GPS, car navigation system . . . ). Other options are also available including the use of RFID (Radio Frequency Identification) tags, proximity sensors, or geo-fencing. For instance, location can be determined when a user moves within a set distance of a proximity sensor or into or out of a geo-fence. While location can determined at a single point in time, it is also to be appreciated that it can be acquired in substantially real-time to enable a user's movement to be tracked, for example. Furthermore, the location component 810 can collect location from multiple suppliers and determine location based on aggregated information.

Moreover, context can include more than simple consumer and advertiser location. In particular, extrinsic data component 820 can receive, retrieve, or otherwise obtain or acquire additional data or information that is useful in advertisement correlation. As used herein, extrinsic data excludes location or explicitly specified profile or preference information, unless otherwise clearly stated. Extrinsic data, however, does include at least that which is outside control of either a consumer or advertiser. Examples of such data include, without limitation, time, temperature, weather, altitude, barometric pressure, time of day, and day of week. Furthermore, extrinsic data can also refer to data or information that is extrinsic to the advertiser while it may be at least to a degree intrinsic to or within control of the consumer. For instance, consider a consumer's proximity to other consumers or velocity. The extrinsic data component 820 can acquire this information in a variety of different ways including via sensors (e.g., user device, external, environmental, proximity . . . ) and third party services, among others. For example, temperature can be determined from a thermometer associated with a mobile device or from a weather service.

Context component 640 can also optionally include a generation component 830 that can produce additional context data based at least upon information from location component 810 and/or extrinsic data component 820. More specifically, the generation component 830 can utilize deductive reasoning, and/or inferences, among other things, to produce higher-level context information from lower-level pieces of context information and/or missing or unavailable information. For example, even if temperature is not known, other information such as altitude, location, season, and month, among other things can be utilized to estimate a temperature.

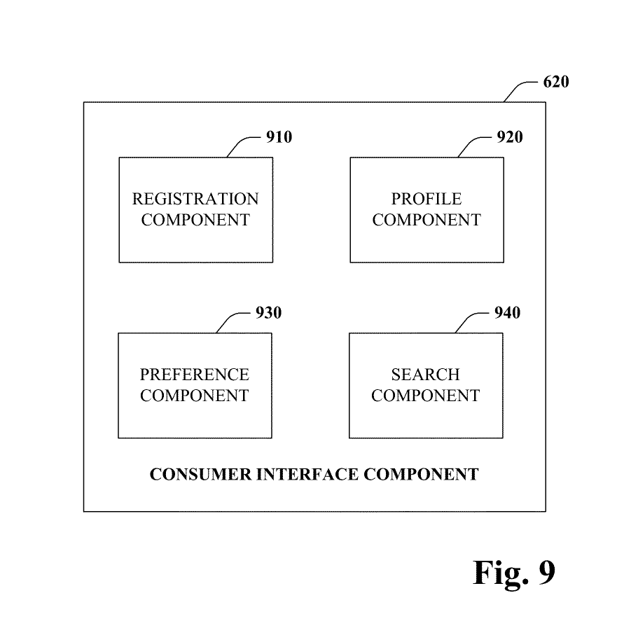

Referring to FIG. 9, a representative consumer interface component 620 is illustrated in accordance with an aspect of the claimed subject matter. The consumer component 620 provides a mechanism for a user or consumer to input data and interact with a mobile marketing system. As shown, the consumer component 620 includes a registration component 910, profile component 920, preference component 930, and search component 940.

The registration component 910 enables a user to register with a mobile marketing system and thereby make them eligible to receive advertisements. For example, the registration component 910 can afford one more graphical user interfaces or wizards to prompt users to enter such information as name, address, phone number, email or the like. A user account can subsequently be created after user information is validated, for instance by sending an email which includes an activation link.

The profile component 920 provides a mechanism for capturing user information about a user or a profile. For example, profile information can include similar things requested during registration as well as other information such as but not limited to birth date, gender, marital status, ethnicity, religion, group affiliations, profession, home ownership status, or other demographic information. Various other information can be entered that aid in defining and/or describing a user. Of course, none of this information is strictly necessary, but any profile information added can later be employed to facilitate location of relevant advertisements.

The preference component 930 facilitates input and receipt of user advertisement preferences or settings. By way of example and not limitation, a user can select categories and subcategories of goods and services of interest, and input keywords and brand/merchant preferences. Other settings can also include size of offers, maximum bid, frequency, privacy settings, temporary settings such as travel, vacation, expiration, and work, and a professional setting. Furthermore, a user can utilize the preference component 930 to specify delivery times and means of delivery and/or notification (e.g., email, SMS, MMS . . . ).

The search component 940 provides a mechanism to search for or otherwise locate advertisements of interest. More specifically, the search component 940 accepts advertisement queries in various forms and returns matching results. In other words, rather than sitting back and waiting for advertisements to be provided to them, users can proactively attempt to locate and acquire advertisements of interest.

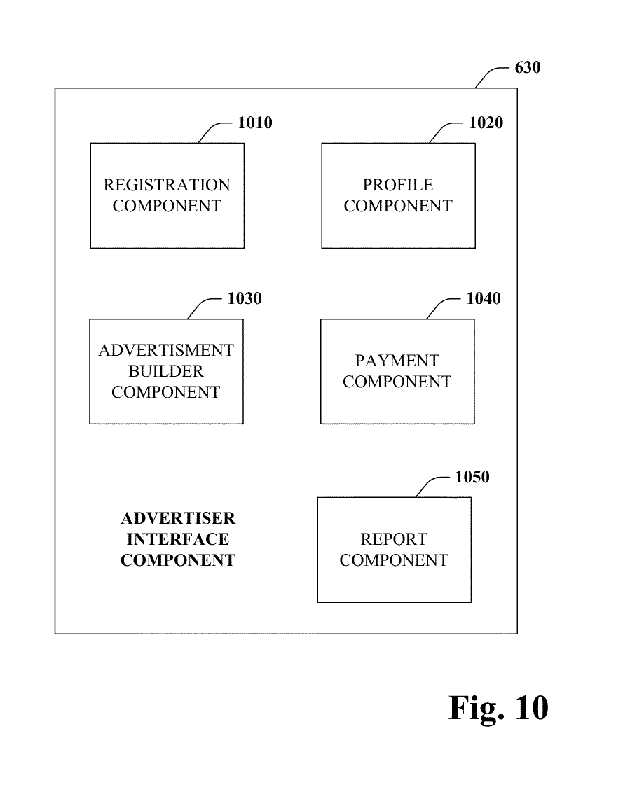

FIG. 10 depicts a representative advertiser interface component 630 in accordance with an aspect of the claimed subject matter. Similar to the consumer component 620, the advertiser component 630 includes a registration component 1010 and a profile component 1020. The registration component 1010 is a mechanism for registering an advertiser or creating an advertiser account. Information can be input utilizing one or more interfaces. Registration information can include, among other things, company name, federal tax id, address, phone, number contact person, and email. After such information is provided and validated via one or more mechanisms (e.g., e-mail activation, challenge response test . . . ), profile information can be entered in a like manner. In addition to registration information, profile information can include business structure information and the identification of additional store information (e.g., chain stores, franchises) and/or information about a particular advertisement or campaign.

The advertiser component 630 also includes an advertisement builder component 1030. As the name suggests, the advertisement builder component 1030 facilities construction of advertisements and/or advertising campaigns. Although not limited thereto, in accordance with one embodiment a series of graphical user interfaces can be presented to an advertiser that guides him/her through such a process. It should be appreciated that preferences or settings can be associated with advertisements at this point including such things as categories, subcategories, keywords, gender, age range, interests, and hobbies, among other things. Further yet, such settings can relate to advertisement and/or campaign validity including but not limited to validity dates (e.g., start date and end date), number of times a user can receive an advertisement, delivery schedule and maximum number of impressions. Together the preferences and settings relating to an advertisement can comprise an advertisement profile.

An advertisement generated by builder component 1030 can take any form that draws attention to or promotes some product or service. Accordingly, the advertisement can simply identify a product via image, audio, video, and/or scent for instance. However, advertisements that are more complex are contemplated including, without limitation, promotions, and/or use of coupons. Furthermore, presentation can differ. In one embodiment, promotional coupons can be produced that include either a promotional alphanumeric code or bar code, for instance. Further, the entire coupon including the promotional code need not be sent initially. For instance, a consumer can be notified of such a coupon first with a description of the product and/or service offer. This can be termed and offer impression. Subsequently, if interested, the consumer request more details including the coupon and promotional code. In other words, the coupon can be activated. Such a request or activation can correspond to clicking on the notification to initiate download of the coupon, texting a message “GET,” sending an e-mail, or placing a call, inter alia. Further, it is to be noted that the advertisement can include or be associated with a host of other information to aid consumers including such things as an advertiser's address and phone number, a map to one or more locations and a link to the advertiser's website, for example. Still further yet, while promotional code can aid in tracking offer usage (e.g., impression, activation, impression), a unique tracking code can also be associated therewith for that purpose.

Payment component 1040 is a mechanism to enable billing or invoice generation and receipt of payment from advertisers. Similar to other advertiser components, various interfaces, graphical or otherwise, among other things, can be employed to provide such functionality. Variations are likely since a multitude of different payment agreements and/or arrangements can be employed. In accordance with one embodiment, an advertiser can be afforded an invoice generated as a function of impressions, activations, and redemptions. Impressions refer to notifications of offers. Request and receipt of the actual offer are activations, and redemptions refer to purchases made that take advantage of an offer. Additionally or alternatively, payment component 1040 can include or be associated with a separate component (not shown) to provide auction functionality to advertisers, for example to bid against each other for the right to afford a user an advertisement in a particular context. It is also to be noted that a user can provide the payment component 1040 with a budget associated with the number of impressions, activations, and/or redemptions in an attempt to cap cost.

Report component 1050 provides information about the performance of an advertisement campaign to an advertiser. For example, number of impressions, activations, and redemptions related to a promotion can be provided. Further, additional information or characteristics of particular consumers can be afforded including those that (1) received an offer but did not activate it, (2) received the offer and activated the offer but did not redeem it, and (3) received the offer, activated the offer, and redeemed the offer. Overall, such information aids advertiser in determining advertisement effectiveness and enables subsequent campaigns to be improved.

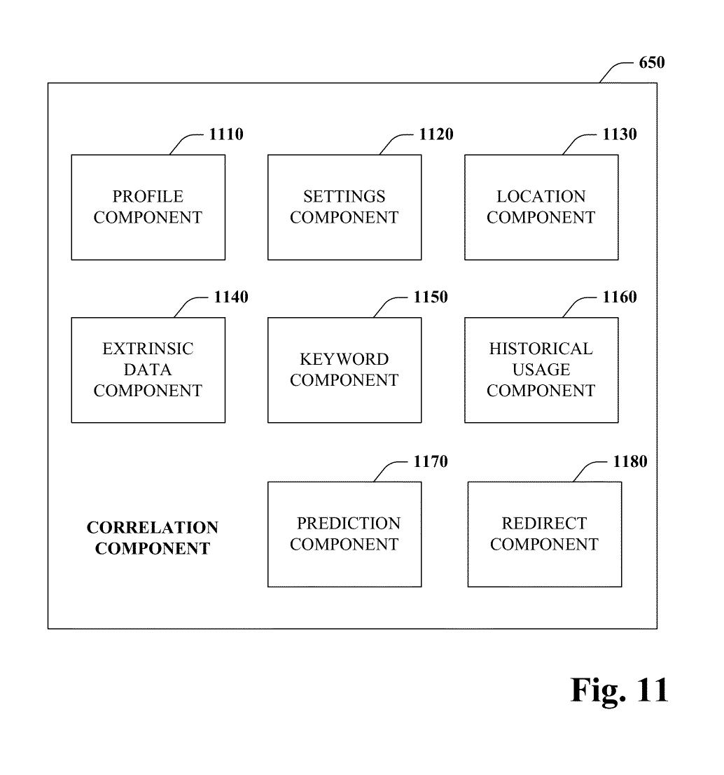

FIG. 11 depicts a representative correlation component 650 in accordance with an aspect of the claimed subject matter. Recall that generally correlation component 650 correlates or matches advertisements to consumers. Matching can be performed in a variety of different ways as a function of a host of different data. Representative correlation component 650 and following description thereof is an attempt to clarify a few ways in which correlation can be performed. Of course, the claimed subject matter is not limited thereto.

Components 1110, 1120, 1130, and 1140 pertain to performing correlation with respect to particular kinds of context information. In particular, profile component 1110 enables matching of advertisements based on consumer profile information. For instance, this can include a consumer's age, gender, marital status, profession, ethnicity, and/or religion, amongst other information. Settings component 1120 allows correlations based on consumer and/or advertising settings. Consumer setting information can include at least categories and subcategories of interest, preferred retailer, and designated time for receiving offers. Advertiser settings can specify characteristics relating to a preferred recipient including, among other things, age, gender, and interests/hobbies as well as campaign categories and subcategories, geographic limits, and keywords for example. Location component 1130 enables matching based on at least consumer location. Extrinsic data component 1140 allows correlation as a function of extrinsic data including without limitation temperature, weather, barometric pressure, altitude, time of day, day of week and/or season. While the correlation component 650 can match based on each of these pieces of contextual information separately, it can also match as a function of all or combinations of such information.

Keyword component 1150 enables correlation as a function of keywords. In one instance, keywords can form part of user and or advertiser settings and matched in that situation. Additionally or alternatively, the correlation component 650 can be employed to directly search for advertisements of interest. In that case, the correlation component 650 can match based at least upon query key words.

Historical usage component 1160 allows the correlation component to match advertisements as a function of historical advertisement usage. In other words, previously received, activated and/or redeemed advertisements or offers can form a basis for future matching. For example, if a user previously redeemed an advertiser's promotional offer, the same or similar offers can be subsequently matched with higher relevance. Furthermore, it is to be appreciated that historical advertisement usage can be employed with respect to not only a single advertiser and consumer but also across all advertisers as well as all consumers or subsets thereof.

Prediction component 1170 enables the correlation component 650 to make predictions or inferences related to advertisements that may be of interest. In one embodiment, affinity groups can be employed as basis for prediction. For example, utilizing various industry models, spectral clustering, and/or micro-segments users can be determined or otherwise classified as members of one or more affinity groups. Subsequently, predictions can be made for specific consumers as a function of group wants, needs, or desires. Furthermore, predictions can be made as a function of one or more models including industry standard models as well as learned or otherwise acquired behavioral models. By way of example, it is known that if a man purchases diapers at a grocery store he will also likely purchase beer. Accordingly, if it can be determined that such a consumer has purchased or is in the process of purchasing diapers an advertisement for beer can be provided. In another instance, it can be determined that a certain path is followed through a mall or other group of proximate stores such a behavioral model can be utilized to ensure that advertisements are afforded to consumers for retailers on that path as the consumer moves.

Redirect component 1180 provides correlation based on competition. When specified, consumers can be directed away from a first advertiser and to a second advertiser by matching advertisements for the second advertiser when otherwise advertisements for the first advertiser are or would be matched. In other words, consumers are redirected to another advertiser. For example, when a consumer is located within a predetermined proximity of a coffee shop A, then an advertisement for coffee shop B can be matched and delivered.

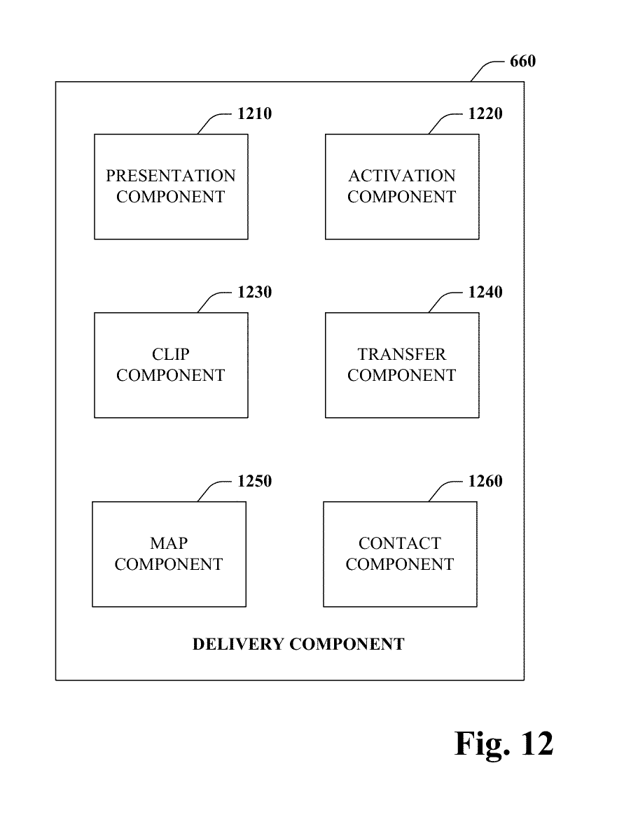

FIG. 12 depicts a representative delivery component 660 in accordance with an aspect of the claimed subject matter. The delivery component 620 includes a presentation component 1210 that provides an advertisement or information about an advertisement to a user. The actual mechanism employed by the presentation component 1210 varies based on preferences/settings and device capability, among other things. For example, an advertisement can be delivered by text message (SMS), multimedia message (MMS), e-mail, or through an application. One or more distribution mechanisms can be employed by the presentation component 1210 to provision advertisements to consumers. For example, information about a promotional offer can be provided to a user via text message as well as e-mail. Moreover, context can be accounted for in determining the best means of notification.

Activation component 1220 enables an advertisement to be activated. As previously described, rather than providing a full advertisement or offer to a consumer upon matching, the consumer can simply be notified of the advertisement. Subsequently, if desired, the advertisement or offer can be requested and acquired. In such a scenario, the presentation component 1210 described above can provide the notification functionality. Activation component 1230 receives a request for a particular advertisement that the consumer was notified of and activates or provides the advertisement to the requesting consumer. The request portion of activation can be performed utilizing different means or mechanisms, which can be dependent upon the notification means. For example, where a consumer is notified of an advertisement by text message, then the consumer might request the advertisement by texting “GET” or the like in a reply to the notification. Alternatively, activation can require calling a particular phone number or e-mailing a specific address, among other things Once requested the actual advertisement or offer can be provided to the user by the activation component 1220 via the same or a different communication medium.

Clip component 1230 is a mechanism for saving an advertisement. Similar to physically clipping or cutting out a coupon, clip component 1230 can save an advertisement or coupon for later viewing, redemption, among other things. By way of example, once a user receives a promotional offer, after activation or otherwise, an option can be provided to clip the offer. If selected, the clipping can be noted by the clip component 1230, and recorded, stored or the like in any manner that enables later retrieval by the consumer.

Transfer component 1240 provides functionality for transferring an advertisement to another consumer. If a consumer acquires an advertisement, offer or the like that he/she believes another person (e.g., friend, family member, colleague . . . ) would desire, it can be transferred to the person utilizing the transfer component 1240. Of course, the means of transfer can vary by capabilities of the sending device and receiving device as well preferences or settings wherein the receiving person is a subscriber, user, member, or the like of the subject advertising system. Transfers to nonsubscribers, nonmembers or the like can be implemented to require subscribing to the advertising service or not.

The delivery component 660 can also include or be associated with a map component 1250 and a contact component 1260 both of which provide added value to advertisement provisioning. The map component 1250 aids a consumer in navigating to a source of the advertisement or offer redemption location. In furtherance thereof, the map component 1250 can provide directions including a map, among other things. The contact component 1260 provides information to facilitate contacting an advertising source such as a retailer. Such information can include an address if not provided by the map component 1250 as well as a phone number and optionally a website if available. In one embodiment, where the retailer operates an online store, the contact component 1260 can direct the user to the store to redeem a promotional offer, for example.

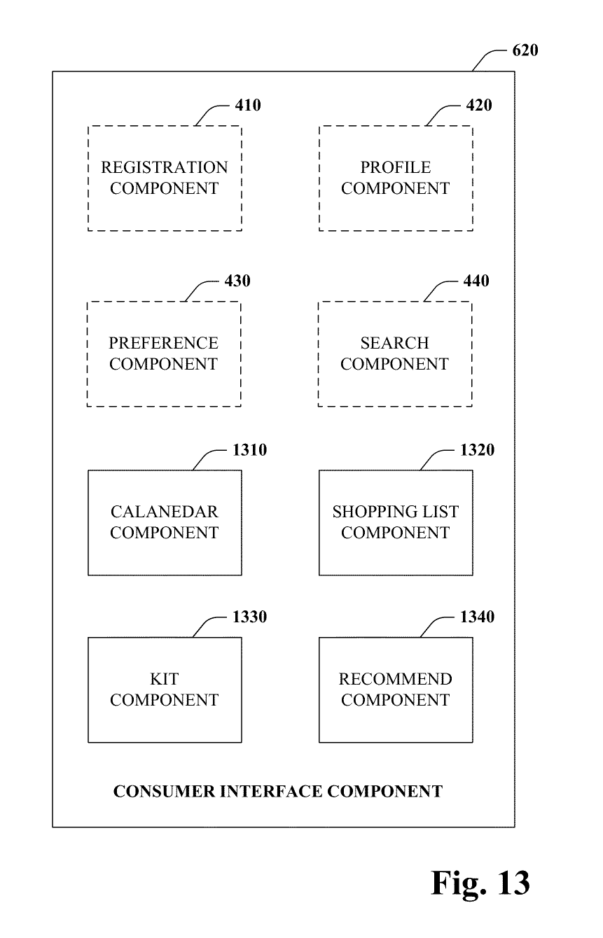

Referring to FIG. 13, a representative consumer component 620 is illustrated in accordance with an aspect of the claimed subject matter. Similar to the consumer component presented in FIG. 9, consumer component 620 includes the registration component 910, profile component 920, preference component 930, and search component 940, as previously described. Among other things, these components aid consumer interaction with a marketing system. The consumer component 620 can also include additional functionality for assisting in acquiring information, as well as providing information.

In particular, the consumer component 620 can include a calendar component 1310 that can facilitate specification and/or acquisition of consumer preferences or other event relevant information. In one embodiment, the calendar component 1310 provides a mechanism to associated preferences or filters and/or categories with particular dates including purchase events. For example, a consumer can add some categories and/or filters to a date associated with a relative's birthday. On or before that date, these filters and categories can be automatically activated. As a result, advertisements will be sent that are tailored to that event. Moreover, users need not specify particular filters but rather can simply identify particular products or services and the calendar component 1310 can automatically generates appropriate filters. Additionally or alternatively, items can be shared with others. For example, one consumer can set up a wish list or the like for events (e.g., birthday, Christmas . . . ) and share them with other users. Upon copying or otherwise receiving this list, the calendar can generate filters automatically and associated them with the particular event date.

Consumer component 620 can also include a shopping list component 1320 that focuses advertisement matching with respect to a particular shopping list. In one embodiment, the shopping list component can aid generation of such a list. Additionally or alternatively, a list can be otherwise acquired such as by upload, download, import or the like. Once acquired, the shopping list can be utilized to adjust categories, filters or the like that influence matching. In one implementation, adjustments based on the shopping list can override at least temporarily other setting since shopping interests are known.

Kit component 1330 enables acquisition of information about kits and employment of the information in modifying categories, filters or the like based thereon. Kits are sets of items employed for a particular purpose. Recipe kits are one example. However, kits can be much more general. For instance, a set of computer equipment including a laptop, mouse, and bag, among other peripherals can be a kit. Upon acquiring information about a desired kit, kit component 1330 identifies kit items and sets filters or the like to facilitate provisioning of promotional offers for the items to enable purchase of the kit at a low cost. It should be noted that a retailer could prepackage all kit items in an attempt to attracted such buyers and offer a discount on the collection of items. Accordingly, a promotional offer associated therewith can be sent to a potential consumer.

The consumer component 620 can also include a recommend component 1340. The subject system is not limited to providing advertisements. In addition or as an alternative, collected information can be utilized to provide retailer advertiser independent recommendations. The same or similar categories, filters, contextual information and the like that are utilized to match advertisements can be employed to simply make suggestions or simply provide valuable information. For example, if a consumer likes pizza for lunch, at lunchtime all local pizza shops can be provided to the user. In another scenario, in a meeting where a salesperson is attempting to land an important client and client representative filters, shopping lists or the like are available, the salesperson can be informed before the meeting that the chief executive officer of the potential client company likes seventeen-year-old scotch.

According to one aspect of claimed subject matter advertisements including promotional offers, coupons and the like can be provided to a user for subsequent redemption at a store. For example, as previously described, an alphanumeric or bar code style promotional code can be provided to a mobile device that can be shown input, shown, scanned or the like at a point of sale. However, claimed subject matter is not so limited in the distribution of promotional offers. In accordance with one embodiment, discounts can be provided to and saved onto loyalty cards or the like. For example, rather than or in addition to providing a promotional offer for a grocery store product to a user via an associated mobile device, the offer can be provided to and saved with respect to the grocery store loyalty card. Accordingly, the discount can be automatically taken on the product upon presentation of the loyalty card. Moreover, the coupon can be provided to multiple loyalty cards for use at more than one store and/or removed after redemption.

The aforementioned systems, architectures, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems above and methods below can include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the dialog component(s) 120, advertisement component 140, and analysis component 130 can all employ such mechanism to facilitate intelligent dialog, analysis, and advertisement generation, among other things. It is also to be appreciated that correlation component 650 and delivery component 660 can employ these mechanisms to infer advertisement matches and when and how to deliver matching advertisements.

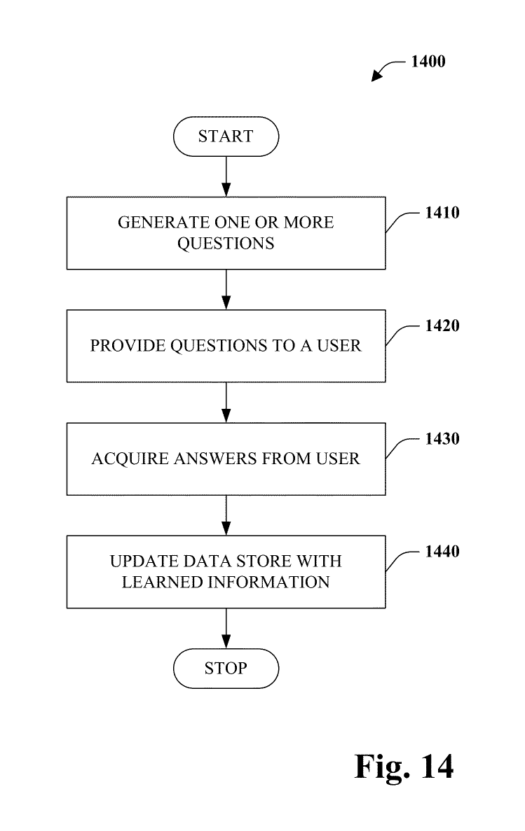

In view of the exemplary systems described supra, methodologies that may be implemented in accordance with the disclosed subject matter will be better appreciated with reference to the flow charts of FIGS. 14-26. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Referring to FIG. 14, a method of actively collecting information from a user 1400 is illustrated in accordance with an aspect of the claimed subject matter. At reference numeral 1410, one or more questions can be generated that are designed to elicit information about a user's preferences, opinions, attitudes, or the like. While such questions can be general questions, it is also to be noted that the questions can be tailored for particular users, for example based current knowledge, previous answers to questions, and/or context information, among other things. By way of example, if it is determined that a user is employing a mobile phone the number of questions provided may be smaller than if the user is utilizing a desktop or other more powerful computer. At numeral 1420, the one or more questions are provided to a user. Again, the manner in which questions are provided can be context dependent. By way of example and not limitation, mobile phone destined questions can be provided in a manner that requires a single response such as a rating from 1-10 or a sliding of a rating bar from one side to another, while desktop questions can employ more open ended questions in a survey format. At reference 1430, answers or responses to the one or more questions are acquired from a use. Subsequently, a data store can be updated with this learned information.

In sum, the method 1400 provides means for teaching a marketing system about a user by engaging the user in a dialog with the system. In accordance with one embodiment, dialog can occur when a user is online and employing a desktop, laptop, or other computer device. Additionally or alternatively, the dialog can be performed with respect to a mobile phone device as a user interacts in the world. Furthermore, it should be appreciated that while dialog can textual in nature it is not limited thereto. Audio and/or video can also be utilized, among other things. For example, speech recognition technology can be employed to allow a user to speak responses to questions.

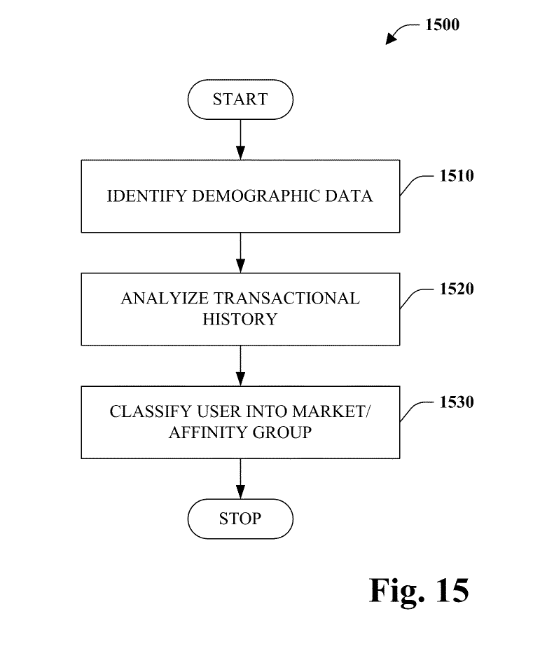

FIG. 15 illustrates a method of data analysis 1500 in accordance with an aspect of the claimed subject matter. At reference numeral 1510, demographic data associated with a user, member or consumer can be identified. Such information can correspond to profile and/or preference information entered by a user, dialog information, and/or information obtained from a third party. At numeral 1520, transactional history is identified and analyzed. The transactional history can correspond to offers viewed, activated, and/or redeemed, among other things. At reference numeral 1530, the user can be classified into one or more market segments or affinity groups as a function of at least demographic and transactional data.

Classification can aid predictive correlation since a user's needs or desires can be linked to one or more groups, for example. Furthermore, a change in groups can allow needs or desires to be attributed to a user even though the user may not yet be aware thereof. For instance, a move from single to married or from married to married with children cause different advertisements to be matched and delivered. In particular, upon birth of a child a user may be moved to such an affinity group and provided with advertisements for the latest most popular infant toy that the user was previously unknown to the user. Of course, it should be appreciated that such groups can be much more specific or granular (e.g., micro segment).

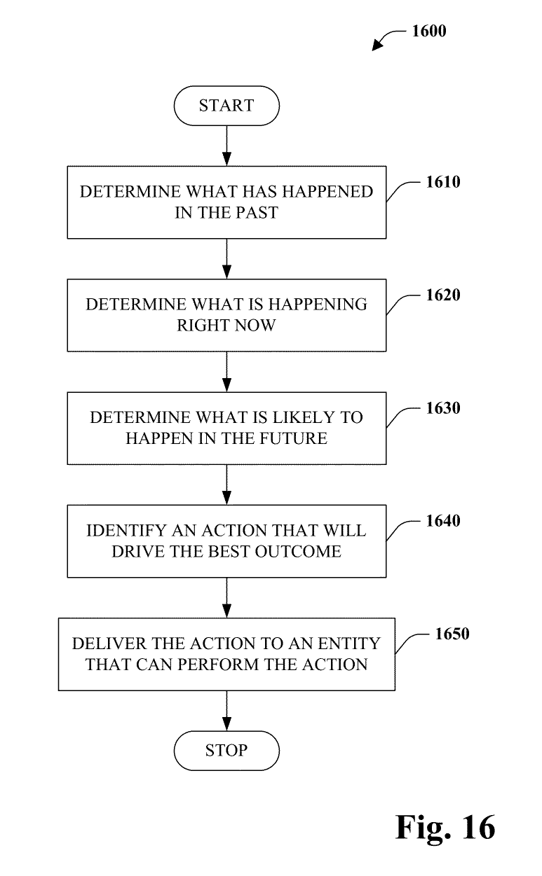

FIG. 16 illustrates a method of data analysis 1600 in accordance with an aspect of the claimed subject matter. At reference 1610, a determination is made as to what has happened in the past. At 1620, a determination is made as to what is happening currently, and at 1630, a determination is made as to what is likely to occur in the future. These determinations can be made at least in part based on current and previously recorded data house in one or more data store, for instance. Furthermore, various statistical, mathematical, and or other algorithmic techniques can be employed with respect to making these determinations. At reference numeral 1640, an action that will drive the best outcome or in other words an optimal action is identified, determined, or inferred. At numeral 1650, the action is delivered to an entity that can perform that action (e.g., individual, computer, system . . . ).

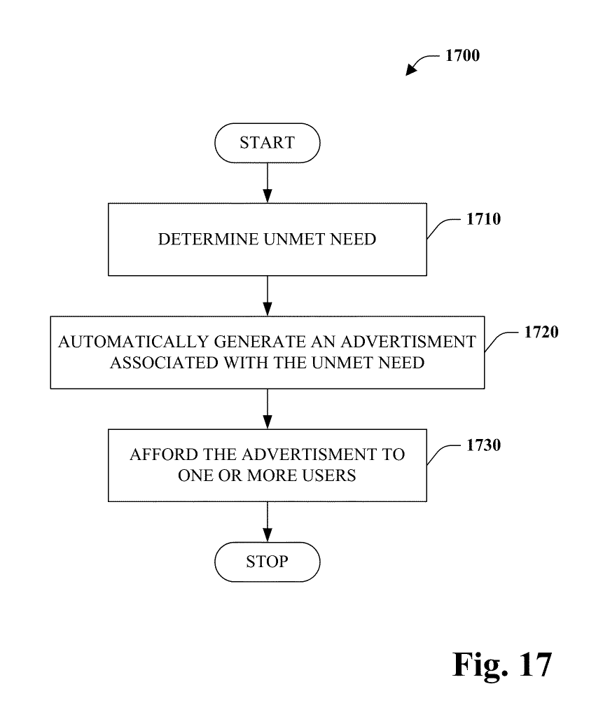

Turning attention to FIG. 17, a method of assisting and advertiser 1700 is illustrated in accordance with an aspect of the claimed subject matter. At reference numeral 1710, an unmet need or desire is determined or otherwise inferred. For instance, the unmet need can be identified based on user information (e.g., profile, preference, dialog . . . ) as well as knowledge of current advertisements, among other things. At 1720, an advertisement can be automatically generated to address the unmet need. Of course, this assumes that an advertiser has provided enough information to enable this automatic generation including such things as graphics, codes, parameters, or the like. This advertisement can then be afforded to one or more users to satisfy their need or desire.

Although not shown, it should be appreciated that an advertiser may need to authorize the generation and/or approve dissemination of the advertisement. At this point, the advertisement could be adjusted prior to affording the advertisement to users (e.g., adjust the discount offer from 20% to 10%). Accordingly, the advertisement can simply be a suggestion. Along those lines, an advertisement need not be generated at all. Rather, the advertiser could simple receive a suggestion or recommendation with respect to a particular advertisement based on an unmet need, for instance, that the advertiser could then use to build an advertisement.

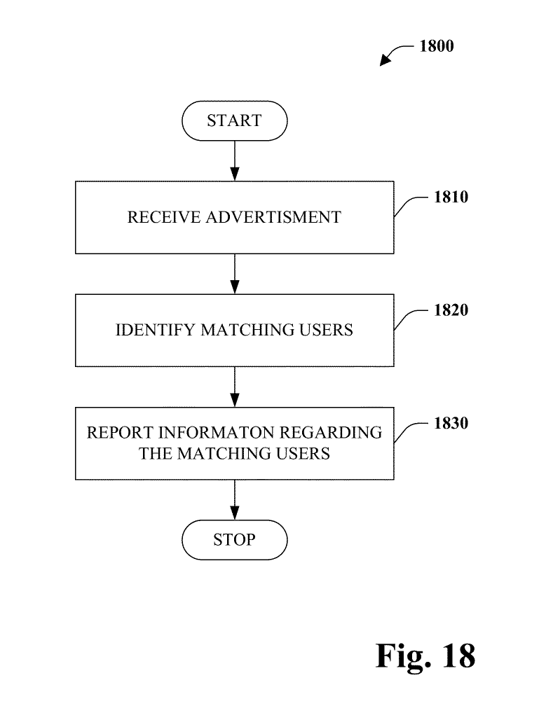

FIG. 18 is a flow chart diagram of a method of concept testing 1800 in accordance with an aspect of the claimed subject matter. At reference numeral 1810, an advertisement is received for testing. Matching users are identified at 1820. In particular, the advertisement can be run through marketing system correlation without delivering the advertisement to users. At reference 1830, information is reported to an advertiser regarding the number of matching users. From this information, the advertiser can choose to modify the advertisement to target additional or fewer users and re-test the modified advertisement. Alternatively, the advertisement can be made live and disseminated to matching users.

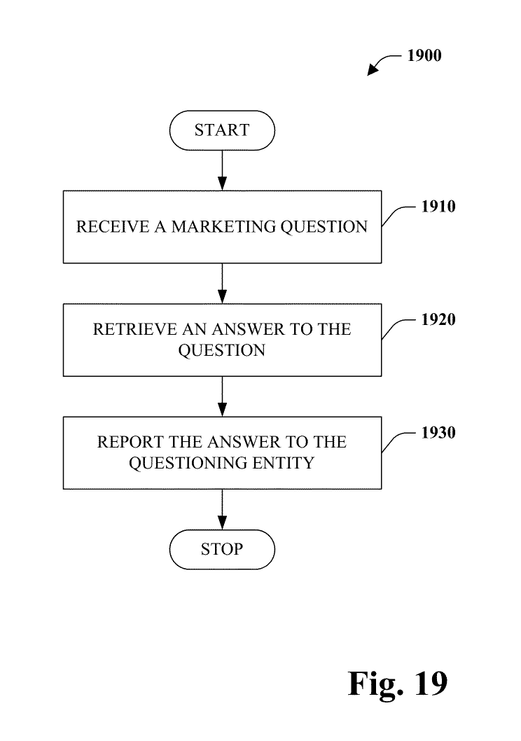

FIG. 19 depicts a method of advertiser inquiry 1900 in accordance with an aspect of the claimed subject matter. At 1910, a marketing question can be received from an advertiser, for example. An answer to the question can be retrieved at 1920. For example, a search can be performed with respect to data collected by a mobile marketing system. At reference numeral 1930, the answer is reported to the questioning entity. In this manner, advertisers or the like can leverage the information collected and/or generated by a mobile marketing system to gain insight into one or more markets for one or more reasons.

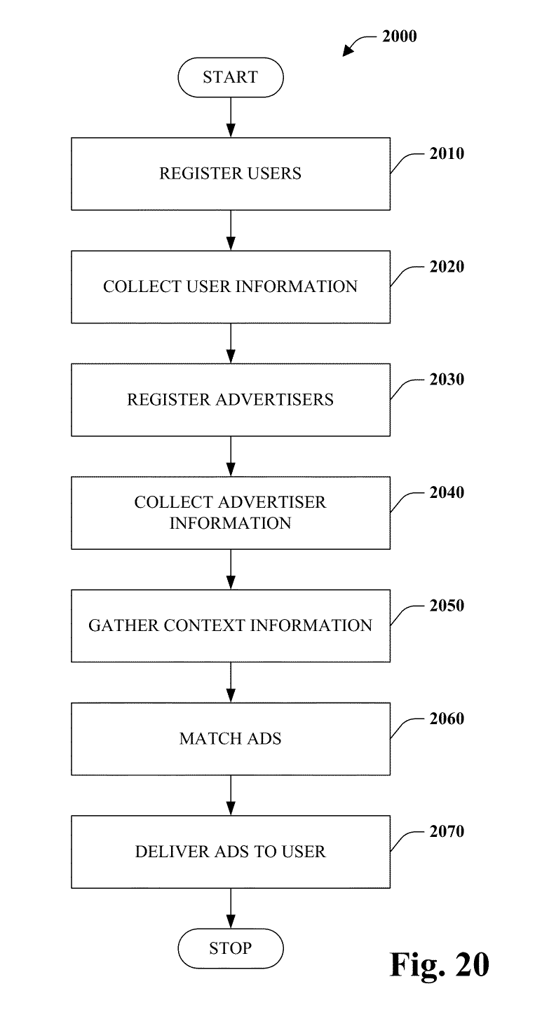

Referring to FIG. 20, a mobile advertisement method 2000 is illustrated in accordance with an aspect of the claimed subject matter. At reference numeral 2010, users or consumers are registered. In other words, users have indicated their desire to receive advertisements and the like by providing basic information. At numeral 2020, user information can be collected. User information can include among other things user profile, preferences and/or settings. For example, a user can indicate that they are a white male age 28 located in Cleveland, Ohio and are interested in casual dining offers delivered weekdays at lunch time. At reference 2030, advertisers are registered. Similar to user registration, advertisers indicate their desire to supply advertisements and the like by providing basic advertiser information. At reference 2040, additional advertiser information is collected including an advertisement or advertising campaign, details, settings such as campaign categories, subcategories, age range, and gender, as well as campaign validity information including start and end dates, maximum impressions, and deliver times. At numeral 2050, context data can be acquired including location and extrinsic data, among other things. At reference numeral 2060, advertisements are matched to consumers as a function of consumer, advertiser, and/or context information. Matched advertisements can subsequently be delivered to users/consumers at numeral 2070.

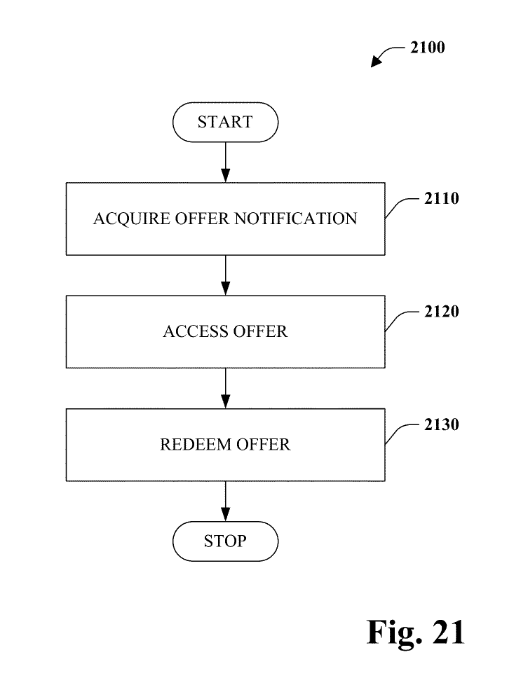

FIG. 21 depicts a method of advertisement employment 2100 in accordance with an aspect of the claimed subject matter. At reference numeral 2110, electronic notification of an offer is provided to a user. For example, such notification can be provided via SMS, MMS, or a local application. In one embodiment, the offer can correspond to products and/or services of interest as determined as a function of one or more of a user profile, user settings, location, and extrinsic data. The notification can provide a brief description of the offer to aid the user in determining whether to further investigate the offer. At numeral 2120, the offer is accessed which includes additional information including a promotional or other unique code (e.g., alphanumeric, bar code), among other things. In one implementation, the offer can be accessed through or with help from the notification. For example, a link can be provided in the notification for navigating to the offer. Alternatively, the notification can facilitate sending a specific text message that will initiate provisioning of the offer. Still further, yet a phone number can be provided in the notification to access the offer. At reference numeral 2130, the offer can be redeemed at a point of sale for purchase of specific products or services. At a physical store, redemption can involve providing the promotional or other code to a user visually, verbally and/or electronically by way of scanning or beaming, for instance. Alternatively, the offer can be redeemed at an online store by entering a particular code or alternatively the code may be automatically entered or provided to the online store.

Note that advertisers can pay or be billed for one or more user action including offer notification (e.g., impression), access (e.g., activation), or redemption. Furthermore, utilizing the promotional code and/or another unique tracking number associated with the advertisement, for example, transactional data regarding impressions, activations, and redemptions can be captured and later employed aid advertisement correlation.

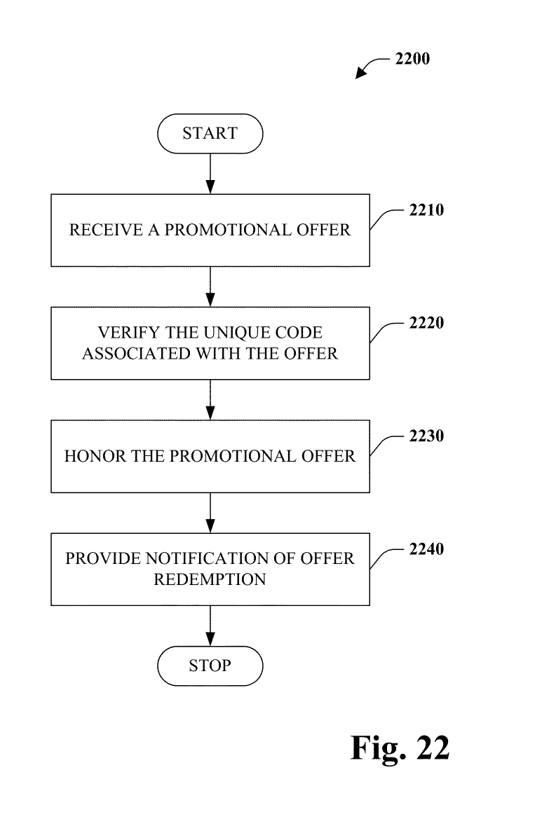

FIG. 22 is flow chart diagram of a method of offer redemption 2200 in accordance with an aspect of the claimed subject matter. At reference numeral 2210, a promotional offer or promotional offer coupon is received. For example, at the point of sale a user can provide a promotional and/or unique tracking code (e.g., numeric, alphanumeric, bar code . . . ) verbally, visually, and/or electronically (e.g., scanner, Wi-Fi, Bluetooth . . . ). At numeral 2220, the unique code is verified, for instance by contacting a mobile marketing system from which the offer was generated. This can ensure not only that the code is valid but also other offer stipulations are satisfied (e.g., validity dates, other product purchases . . . ). At reference 2230, the promotional offer is honored for example by discounting the price of a product or service. Subsequently or concurrently, at 2240, notification is provided of offer redemption. For example, mobile marketing system or some other service can be notified. In one instance, a specific database can be updated to reflect the honoring of the offer.

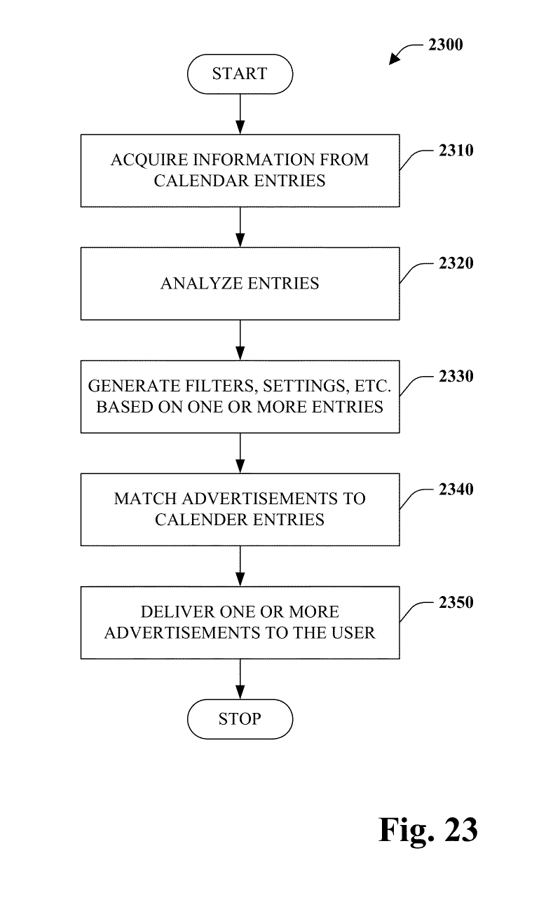

FIG. 23 is a flow chart diagram illustrating a method of advertising as a function of calendar entries in accordance with an aspect of the claimed subject matter. At reference numeral 2310, information is acquired or otherwise identified with respect to a calendar. In one implementation, utilizing a calendar (including calendars provided by a third party), events important to a particular user or otherwise can be captured. Moreover, additional information can be associated with an event. For example, not only can a child's birthday be noted on the calendar but it can also include information pertaining to gifts the child may like. Such products and services can be noted explicitly on such a date or filters or the like can be set that correspond to such products or services. Furthermore, the child can share his or her preferences with the user that can be associated with the date or a birthday wish list or the like can be linked to the date. At numeral 2320, calendar entries are analyzed and at reference 2330 filters, settings or the like are automatically generated based on one or more entries. Not only can filters be generated automatically to transform specifically or generally identified products or services into filters, but additional filters can be added that relate thereto. In this manner, filters can be added that identify potential items that may also be of interest. For example, if a child desires a particular gaming system, then filters can also be generated for associated games. Moreover, generation can be much more complex such that knowledge of interest in a gaming system can imply interest in a particular book for which filters can also be generated. At reference numeral 2340, advertisements are matched to calendar entries for example utilizing generated filters, settings or the like. At numeral 2350, one or more advertisements are delivered to the users at a predetermined time before and even on a particular date. Furthermore, it is to be appreciated that where calendar events employ shared lists, they can operate like a registry such that once someone has indicated that they have purchased something explicitly or implicitly by use of an offer for example, the item can be removed from the list and users will not be provided with coupons for such items.

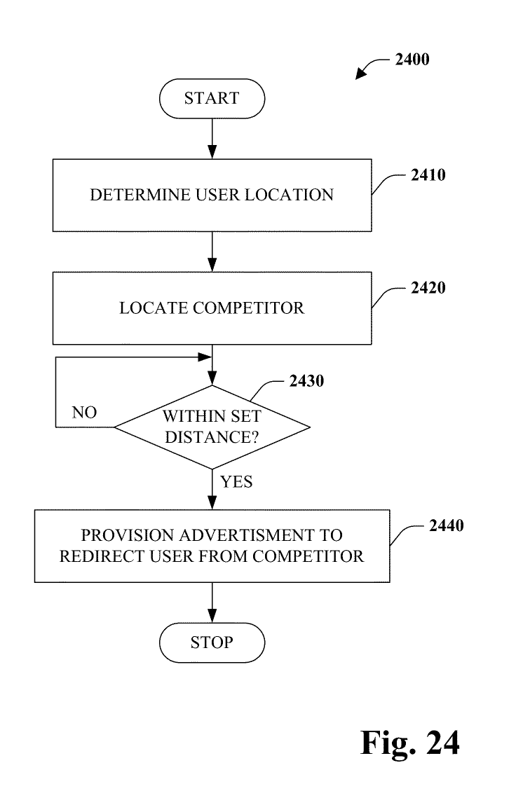

FIG. 24 illustrates a method of advertisement distribution 2400 according to an aspect of the claimed subject matter. At reference numeral 2410, a user's geographical location is determined. For example, location can be determined based on substantially real-time tracking via GPS for instance, utilizing proximity sensors, and/or network transmission triangulation, among other things. At reference 2420, a competitor or competing merchant is located. For example, a competitor's stores can be identified with respect to an address and/or coordinate system. At reference numeral 2430, a determination is made as to whether a user is within a set distance of an identified competitor. If no, the check continues on updated locations. If yes, an advertisement is provisioned to the user to redirect the user away from a competitor location at 2440.

By way of example and not limitation, consider two coffee shops “A” and “B,” where “B” is an advertiser subscribing to such a service. When a user approaches coffee shop “A,” they can be provided with an advertisement for coffee shop “B.” This is especially helpful to a user who prefers coffee shop “B” to coffee shop “A.” In this instance, an advertisement can be provided with a message identifying the closest location of coffee shop “B.” Where coffee shop “A” is also an advertiser subscribing to services described herein an auction can be held to determine whether an advertisement for coffee shop “A” or coffee shop “B” will be presented upon proximate location of a user.

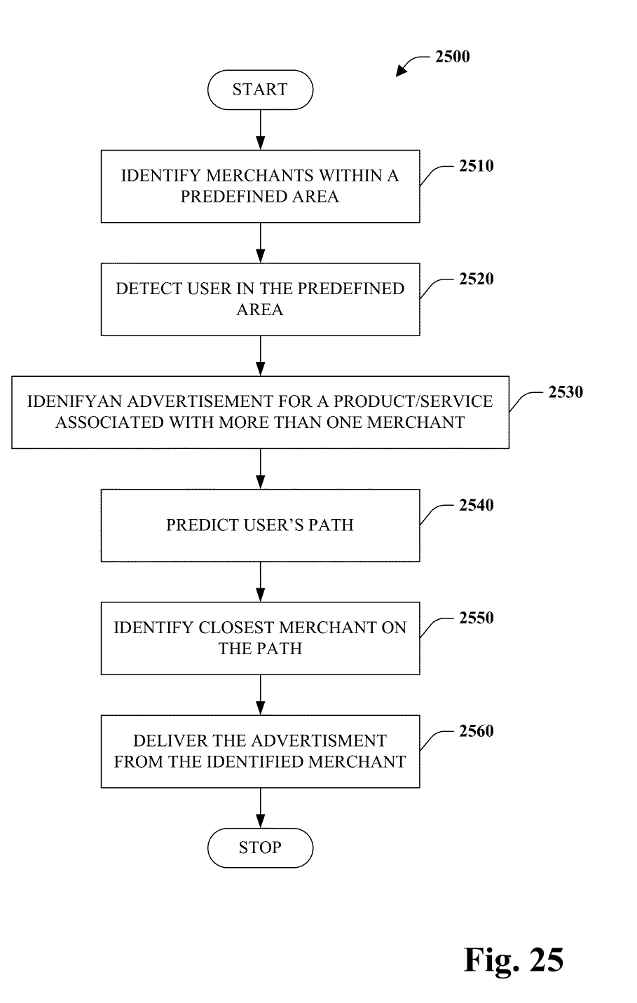

FIG. 25 depicts a method 2500 of advertising as a function of a behavior model in accordance with an aspect of the claimed subject matter. At reference numeral 2510, a number of merchants within a predefined area are identified. For example, such merchants can be mall tenants. At 2520, a user is detected within the predefined area. In the example, the user enters or approaches a mall. At numeral 2530, an advertisement for a product or service provided by more than one merchant is identified. A user's path is predicted based on a variety of factors including, among other things historical paths or behavior models. For example, one particular user may visit all stores on a first side and then all stores on a second side while a different user may prefer to visit stores in a zigzag pattern. At reference 2550, the closest advertising merchant on the user's path is identified. Finally, at 2560, the advertisement from the closest merchant is delivered to the user.

While location is a factor in generating a sale, location alone may not be enough. For example, consider a situation in which at the time an advertisement is identified the stores offering a desired product or service are equidistant from a user yet one merchant is behind the user and one merchant is in front of the user in terms of a particular route. For instance, maybe parking caused the user to enter from a different location than normal. It is more likely that an advertisement associated with a merchant on the user route will generate a sale rather than one that requires the user to backtrack or modify his/her route.

Furthermore, merchants within such a predetermined distance that sell the same or similar products or services can simply agree to such a distribution of advertisements or other schemes can be used. For example, merchants can enter into a revenue sharing situation such that a close merchant on a path shares a portion of the purchase cost with a distant merchant or a merchant of a user's path. In this manner, overall sales can be increased and all merchants benefit. Additionally or alternatively, an auction can take place such that an advertisement associated with the closest merchant on the path is not required.

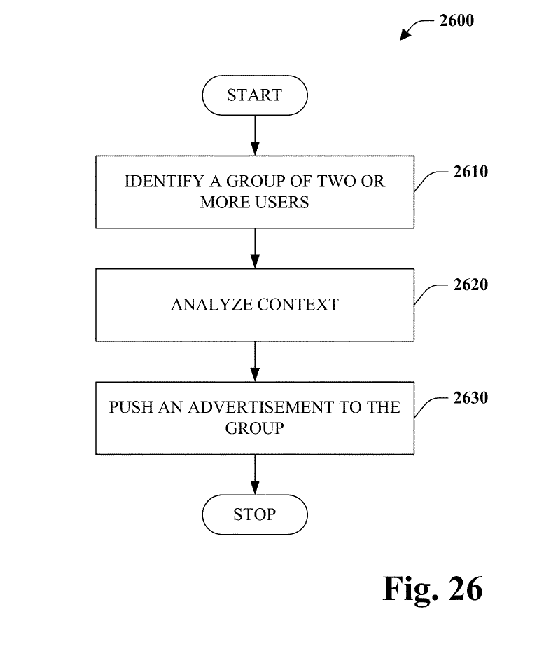

Referring to FIG. 26, a group advertising method 2600 is illustrated in accordance with an aspect of the claimed subject matter. At reference numeral 2610, a group of two or more users is identified. For example, based on GPS location, proximity sensor, or like data it can be determined that number of people or within a set particular distance of one another. At numeral 2620, context is analyzed including each individual's profile, settings and the like as well as other extrinsic information. Furthermore, it should be appreciated that context can include a determined or inferred group activity. Based on this analysis, an advertisement is pushed to one or more members of the group at reference numeral 2630. While the advertisement can simply promote a product or service or offer a discount upon purchase thereof, it can also be couched in more entertaining format so as to encourage the group to talk about it. For instance, it can be a funny video clip or image including reference to the advertiser and an option coupon or discount code.

By way of example and not limitation, consider a situation where a number of colleagues are conversing at the end of a workday. Based on their proximity they can be defined as a group. Thereafter, similarities can be analyzed to produce essentially a group profile, settings, and the like. In this case, it might be determined that the group is interested in beer specials associated with local bars and restaurants. Accordingly, advertisements associated there with can be matched. However, this can further be narrowed by extrinsic data such as the weather. If it is considered nice outside, namely warm and sunny, the advertisements can be further limited to establishments with outside patios. Further yet, if there is a basketball game, which one or more group members plans or would like to attend, then advertisements can further be linked to bars or restaurants close to the event. A matching advertisement can then be provided to one or more of the group members. In one instance, the advertisement can be provided to all group members to improve the effect of an advertisement. However, a group member may not be notified if they have another event that would conflict with meeting colleagues for drinks even though they otherwise would participate. Furthermore, the advertisement may only be provided to a determined group leader such as a supervisor, major or otherwise outgoing individual.

Among other things, the user dialog, disclosed herein, can be leveraged to obtain information regarding a mobile marketing system brand, advertisers' brands, advertisers' advertisements, and how they will be perceived in the marketplace. The central “general contractor” perspective of providing advertisements for advertisers allows the marketing system to see the competitive advantages that advertisers possess as compared to their competition. This central perspective enables the system to recommend advertisements that build these identified advertiser advantages into future marketing messages. Companies that apply this technique present a believable and consistent brand messages to their customers and several benefits are realized as a result.

First, marketing campaign effectiveness can increase with improved response rates. This can be accomplished by providing advertisers with pre-calculated micro segmentation (e.g., market segments, affinity groups) along with predictive analysis to support tactical advertisement generation.

Second, sales revenue can be increased in a number of ways. For instance, wallet share or the overall proportion of income designated for a merchant is increased for each customer. Additionally, cross selling and up selling opportunities are enhanced.

New markets or micro segments are also created for merchant products and services by fine tuning advertisements to satisfy more micro segments with slight alterations that completely match consumer desires. For example, alterations can include applying discounts to products of certain colors, quality, logos, sizes, and/or capabilities, among other things.

New customers can also be acquired by introducing an advertisers advertisement to members how recently entered a monitored micro segment or affinity group. This occurs over time, as a member's transaction history groups and the member continually specifies his/her needs. Further, unit margins can be increased with respect to old as well as new customers.

Furthermore, attrition is reduced for a number of reasons. First, loyalty is increase through active learning and relationship marketing, because it makes in more difficult for a member to expend time and effort searching for a competitor's offer that satisfies his preferences at the same level such as product, price, location, integration in lifestyle, etc. Second, customer service is inherently improved. In addition, an advertiser is provided with a competitive advantage over others since advertisements are tailored to an individual's preferences and integrated into daily lifestyle. Finally, customer satisfaction is increased with advertisements that recommend products and services that match the remembered member's preferences and purchasing trends.

Interactive Health and Wellness System

In addition to the advertising and marketing applications described above, one or more of the active learning and advanced relationship building aspects described herein can be applied in the context of a health and wellness system. The health and wellness system can utilize active learning and relationship building to provide users with personalized health management information. Information provided by the health and wellness system can include, but is not limited to, medication does reminders, information regarding potential health issues the user is at risk of experiencing, disease state education, recommendations for lifestyle changes designed to mitigate risks associated with the user's current or potential health problems, customized incentives for participating in recommended wellness programs, and other such information. Through interaction with the health and wellness system, the user can selectively explore recommended wellness programs designed by the system to address current or predicted health concerns, allowing the user to control his or her level of participation in the recommended programs. The health and wellness system can also dynamically adjust the recommended wellness programs based on the user's progress or other feedback provided by the user.

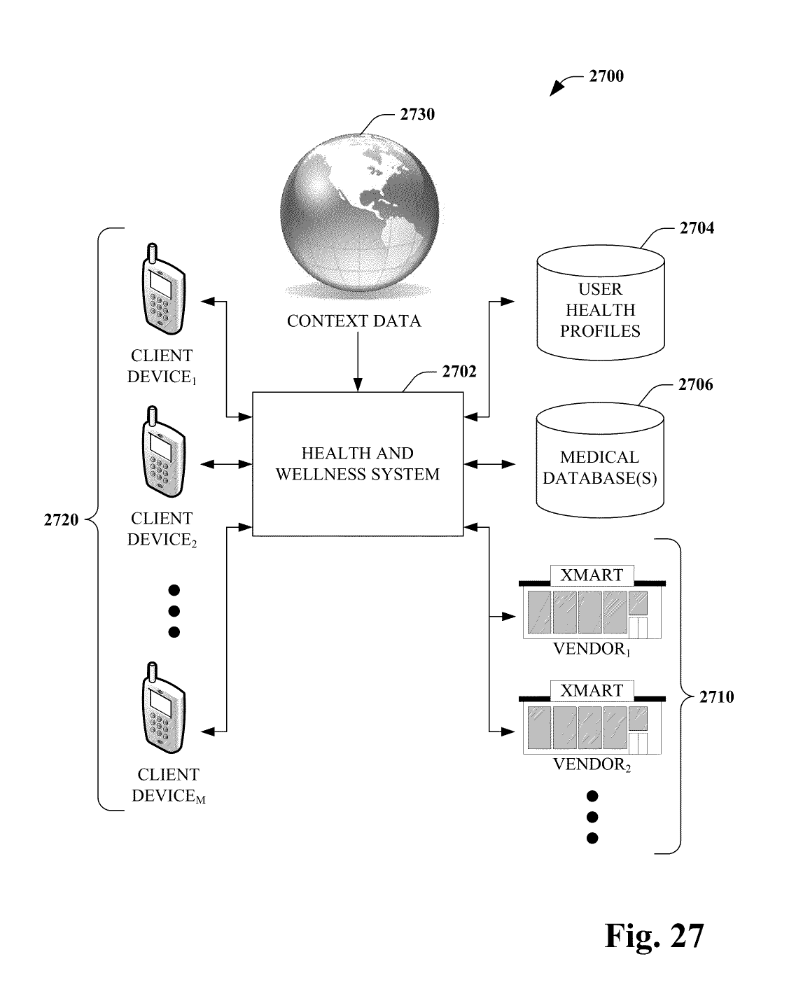

FIG. 27 depicts an exemplary environment 2700 in which the health and wellness system 100 can be utilized. In one or more embodiments, health and wellness system 2702 can be hosted by a server or infrastructure accessible by one or more client devices 2720 (e.g., via the Internet). In some implementations, health and wellness system 2702 can reside and execute on a web-based infrastructure (e.g., as a remote Internet-based service, as a cloud-based service running on a cloud platform, etc.), and its associated services can be provided to users via a software-as-a-service (SaaS) delivery model. In one or more embodiments, access to health and wellness system 2702 can be provided to customers as a subscription service. Alternatively, health and wellness system 2702 can be operated privately (e.g., on a private cloud or network server) and made available to selected users associated with an owner of the system.

As will be described in more detail below, health and wellness system 2702 can deliver customized health and wellness information to users via client devices 2720 based in part on personal information provided by the users. To this end, health and wellness system 2702 can maintain one or more user health profiles 2704 corresponding to respective users of the system. Each of the user health profiles 2704 can be associated with a user identifier, and stores relevant personal and medical information for the user. This personal information can comprise personal data provided by the user (e.g., via client devices 2720) as well as information retrieved or derived from the user's medical records.

Health and wellness system 2702 can also acquire context data 2730 indicative of the user's current context or environment. As described above in connection with the mobile marketing system, context data 2730 can include, but is not limited to, the user's location, the current time or day, weather or climate conditions at the user's current location (e.g., temperature, precipitation, humidity, barometric pressure, smog levels, etc.), the user's current altitude, the user's proximity to other people, etc. Context data 2730 may also include other medically relevant environmental factors, such as pollen count, ozone levels, air quality index, etc.

Health and wellness system 2702 can be configured to access one or more medical databases 2706 to facilitate generation of accurate and useful medical information and recommendations to the user. Medical databases 2706 can comprise a collective knowledgebase of medical information relating to medical conditions, treatments, allergies, preventative measures, environmental factors that can aggravate existing medical conditions or trigger allergic reactions associated with certain medical conditions, or other such medical information. In one or more embodiments, health and wellness system 2702 can access medical databases 2706, such as databases provided by Electronic Medical Record (EMR) systems, in view of a user's medical information (as recorded in user health profiles 2704) and context data 2730 to facilitate generation of personalized health recommendations, environmentally triggered health alerts, medication schedule notifications, recommendations for preventative care, information regarding un-diagnosed conditions for which the user is at a high risk, or other customized health information.

Health and wellness system 2702 can also access product information associated with one or more vendors 2710. The product information can relate to products or services offered by the respective vendors 2710, promotional offers published by the vendors 2710, etc. Health and wellness system 2702 can use the vendors' product information in a number of ways. For example, in some embodiments, the system can generate user incentives in the form of discounts, co-pay, and coupons for relevant medical products or services. In another example, health and wellness system 2702 can direct a user to a vendor that provides products and services relevant to a medical recommendation sent to the user. The system may also provide general information regarding available products and services that may be of interest to the user in view of a particular medical condition.

Client devices 2720 can comprise mobile devices similar to mobile devices 720 (e.g., mobile phones, palmtop computers, laptop computers, tablet computers, netbooks, PDAs, music playback devices, electronic book readers, etc.). Client devices 2720 may also be Internet-capable destktop computers or workstations capable of exchanging data with health and wellness system 2702 over an Internet connection or other network connection.

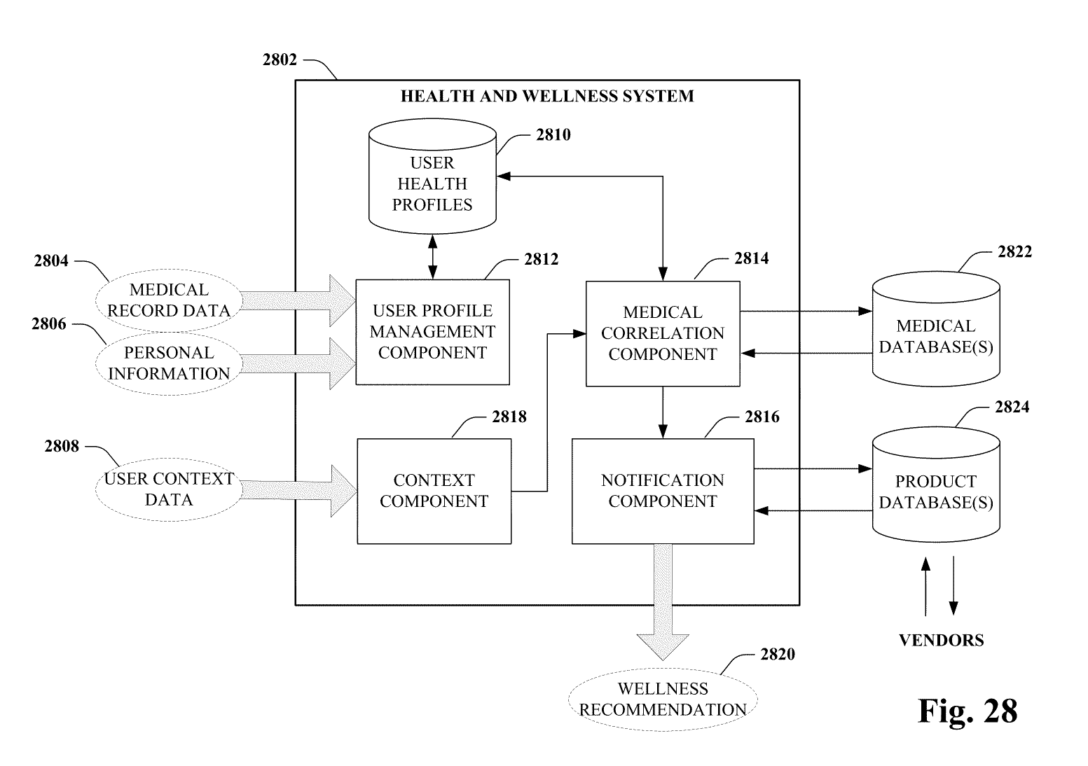

FIG. 28 is a block diagram of an exemplary health and wellness system capable of providing wellness recommendations according to one or more embodiments of this disclosure. Health and wellness system 2802 includes a user profile management component 2812 that maintains a set of user health profiles 2810 corresponding to respective users. User health profiles 2810 record personal and medical information for respective users of the system. Information recorded in user health profiles 2810 can include, but is not limited to, user identification, contact information, height, weight, blood pressure (last measured or average), body mass index (BMI), diagnosed medical conditions, family medical history, known allergies, medications the user is currently taking, scheduled medical examinations, etc. User profile management component 2812 can create and update user health profiles 2810 based in part on personal information 2806 and medical record data 2804 received from external sources. For example, user profile management component 2812 can receive personal information 2806 directly from the user via the user's personal device (e.g., client devices 2720 of FIG. 27). Medical record data 2804 can be received from one or more medical databases maintained by the user's physician, or provided to the system manually by the user's physician.

In some embodiments in which health and wellness system 2802 is made available as a subscription service, when a user subscribes to the system, user profile management component 2812 can be configured to access a source of the user's medical records and to retrieve relevant medical information from the records for storage in the user's health profile. In such embodiments, changes to the user's medical record may be sent automatically to health and wellness system 2802 so that user profile management component 2812 can update the user's health profile accordingly. Alternatively, the user's physician can access health and wellness system 2802 via the Internet or other network and manually provide the user's medical record data 2804 to the user profile management component 2812. To facilitate entry of the user's medical record data 2804 and personal information 2806, health and wellness system 2802 can serve one or more preconfigured interface displays to the user's (or physician's) client device. These displays can include appropriate data entry fields for accepting the user's personal and medical information. After the user's health profile has been created, user profile management component 2812 can thereafter dynamically update the profile as new user information is received (e.g., a newly diagnosed conditions, updated blood pressure measurements, etc.).

Health and wellness system 2802 also includes a medical correlation component 2814 and a notification component 2816. Medical correlation component 2814 is configured to correlate information in user health profiles 2810 with medical knowledgebase information stored in one or more medical databases 2822. Medical databases 2822 can comprise virtually any source of medical information accessible by health and wellness system 2802. For example, medical databases 2822 can comprise external sources of information, such as online resources, externally maintained medical knowledgebases (e.g., hospital or university knowledgebases), or other sources of information. In some embodiments, medical databases 2822 can comprise one or more locally maintained medical knowledgebases associated with the health and wellness system 2802. In such configurations, medical databases 2822 can be updated and maintained by an administrator of health and wellness system 2802.

Medical correlation component 2814 can correlate user health profile information with medical knowledgebase information in a number of ways. For example, if a user's health profile indicates that the user suffers from high blood pressure and that the user's body mass index is high, medical correlation component 2814 can correlate this information with knowledgebase data stored in medical databases 2822 to determine that losing ten pounds may reduce the user's blood pressure. Based on this determination, notification component 2816 can deliver a wellness recommendation 2820 to the user's client device suggesting this course of action. The wellness recommendation 2820 can also include other information intended to raise the user's awareness of the possible health risks inferred from the user's health profile (e.g., the long-term effects that high-blood pressure can have on the user's health). Wellness recommendation 2820 can also include suggested weight-loss regimens that can be adopted by the user to effect weight loss, recommended weight loss products, dietary recommendations, or other such information.

In general, medical correlation component 2814 can cross-reference a user's physical and medical information with medical knowledgebase information to predict potential future health issues for which the user is at risk, and to determine proactive courses of action that may mitigate such future health issues. In making such determinations, medical correlation component 2814 can also consider current medications the user is taking and their known side-effects, which may limit or alter the type of wellness recommendation 2820 issued to the user.

Wellness recommendations 2820 can also be triggered or customized based on conditions of the user's immediate environment. For example, some medical conditions are known to be aggravated in response to certain environmental triggers, such as high pollen count, ozone levels, high or low temperatures, humidity, etc. Accordingly, health and wellness system 2802 can include a context component 2818 configured to receive user context data 2808 indicative of the user's environmental context. Context component 2818 can be similar to context component 640 described above. User context data 2808 can include such information as the user's location, time, temperature, altitude, barometric pressure, pollen or ozone levels, humidity, or other extrinsic data that may have an impact on the user's health. Medical correlation component 2814 can correlate user context data 2808 associated with a particular user with the user's health profile and knowledgebase data stored in medical database(s) 2822 to determine whether the user's current environment warrants delivery of a wellness recommendation 2820 to the user's client device.

For example, a user's health profile may indicate that the user currently takes a medication that may induce a photoallergic or phototoxic reaction. This characteristic of the medication may be explicitly indicated in the user's health profile, or may be ascertained by medical correlation component 2814 by retrieving information about the medication from medical database(s) 2822. Moreover, user context data 2808 may indicate that it is currently daytime at the user's location, and that the skies at the user's current location are clear and relatively cloud-less. Based on this information, medical correlation component 2814 may determine that the user is highly susceptible a photoallergic or phototoxic reaction (e.g., a rash or burn) if ventures outdoors. Accordingly, medical correlation component 2814 can instruct notification component 2816 to issue a wellness recommendation 2820 to the user's client device suggesting that the user stay indoors, and informing of the risks involved should the user spend an excessive amount of time outdoors. The recommendation can optionally include a link to additional information relevant to the notification should the user wish to better understand the reason for the notification (e.g., a list of side-effects associated with the medication). Wellness recommendation 2820 may also include tips for mitigating the risk of photoallergic or phototoxic reactions should the user decide to ignore the warning and spend time outside (e.g., recommending applying a sun blocking lotion).

In another example, the user's health profile may indicate that the user suffers from rheumatoid arthritis. By accessing medical database(s) 2822, medical correlation component 2814 may determine that some symptoms of rheumatoid arthritis, such as joint stiffness and pain, are amplified by high humidity and/or low barometric pressure. Accordingly, when user context data 2808 indicates that the climate at the user's present location is currently experiencing either of these conditions (or that high humidity/low barometric pressure is being forecast for the user's location in the near future), notification component 2816 can deliver a wellness recommendation 2820 to the user's client device alerting the user of the impending risk of heightened arthritic symptoms. Wellness recommendation 2820 may also recommend general or specific products (e.g., oral medications or ointments) that may alleviate the symptoms associated with the identified climate conditions. If the user's health profile indicates that the user is currently taking a medication to control arthritis symptoms, notification component 2816 may generate the wellness recommendation 2820 to include a recommendation to ensure the user keeps the medication in his possession in the event that an increases dosage is necessary because of the anticipated climate-triggered symptoms. The amount of a recommended dosage increase can be based in part on a current medication schedule recorded in the user's health profile, such that the recommended dosage increase does not violate a physician's recommended dosages. Medical correlation component 2814 can also consider other medications the user is currently taking to ensure that increasing the dosage of the arthritis medication is not likely to cause undesirable side-effects as a result of mixing the respective medications and dosages.

As noted in the previous examples, wellness recommendation 2820 may sometimes include recommendations for products relevant to the user's current or predicted medical issues. In one or more embodiments, health and wellness system 2802 may access one or more product databases 2824 or other product data storage to identify particular products that may be of potential benefit to the user. In some configurations, product database 2824 can be an integrated component of health and wellness system 2802, and can include cataloged data relating to products or services offered by one or more vendors or service providers. For example, an administrator or owner of health and wellness system 2802 may partner with one or more product or service vendors and offer those vendors a platform through which to target advertisements, offers, or discounts to users who may be interested in their products. Vendors may provide information regarding products, services, or discount offers, and this information can be stored on product database 2824. Product database 2824 can catalog the product data according to their relevance to particular medical conditions, symptoms, etc. In other configurations, product database 2824 may comprise multiple distributed sources of product information external to health and wellness system 2802, such as websites or servers maintained by individual vendors. In such configurations, health and wellness system 2802 may access these external sources of product information to locate relevant products and services being offered by the respective vendors.

Thus, in connection with generating wellness recommendation 2820, notification component 2816 can access product database 2824 to determine one or more offered products or services that may be relevant to the recommendation. For example, in the rheumatoid arthritis example described above, notification component 2816 may access product database 2824 to identify medications or ointments designed to alleviate arthritis pain and stiffness. Notification component 2816 may also determine whether there are any coupons or discounts associated with the identified product. Based on these determinations, notification component 2816 can generate a wellness recommendation 2820 that includes both a warning of increased risk of arthritis symptoms as well as a recommended medication or ointment that may alleviate the expected symptoms. The wellness recommendation 2820 may also include a coupon for the recommended product if a valid coupon for the recommended product is available.

Product or service recommendations generated by health and wellness system 2802 can be made in view of additional medications the user may be taking that are not relevant to the particular condition addressed by the wellness recommendation 2820. For example, if notification component 2816 identifies that a user's current environmental context (e.g., elevated pollen count) increases the likelihood of allergic symptoms, notification component 2816 may access product database 2824 to identify one or more off-the-shelf medications that may mitigate the identified symptoms. However, before including a recommendation for these products in the wellness recommendation 2820, medical correlation component 2814 can determine whether the identified medications are likely to interfere with other medications the user is currently taking, or whether there are hazards associated with combining the identified medications with the user's existing medications. Medical correlation component 2814 can make this determination by identifying other medications recorded in the user's health profile, accessing medical database(s) 2822 to determine whether there are known risks associated with combining the recommended medication with the existing medications identified in the health profile, and deciding whether to include the recommended medication in the wellness recommendation based on the determination. If no potential risks are identified, notification component 2816 can provide the medication recommendation to the user. Alternatively, if potential risks are identified, wellness recommendation can omit the medication recommendation from wellness recommendation 2820.

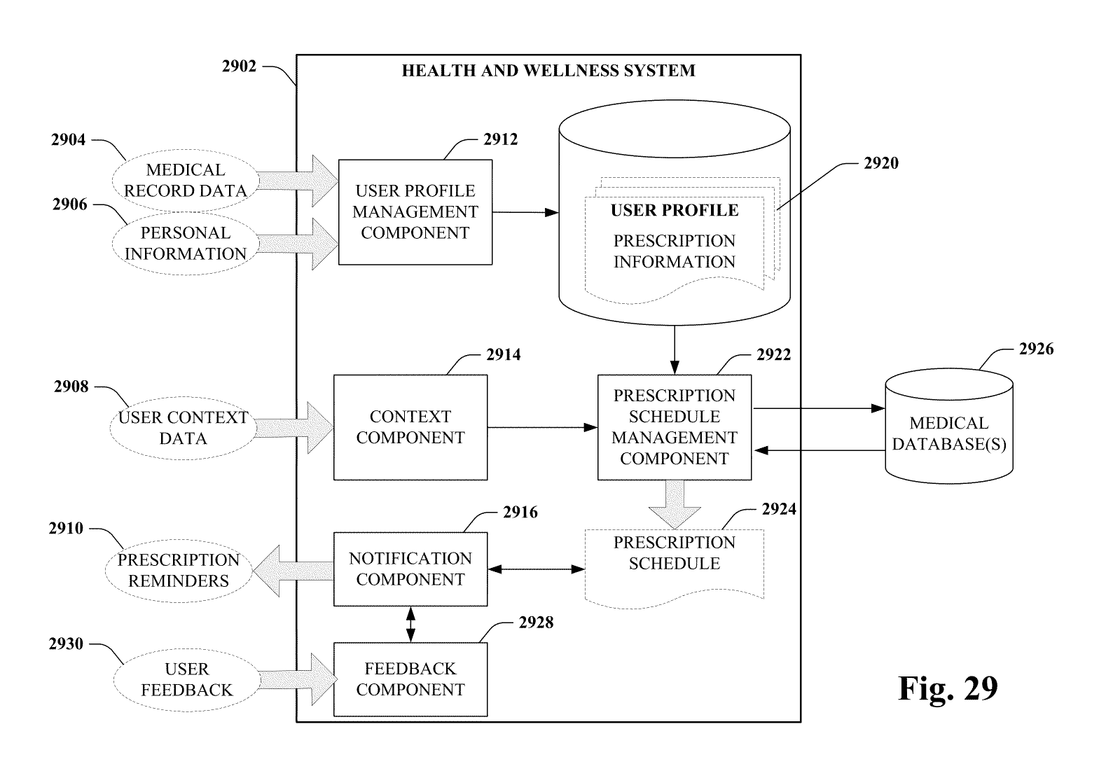

One or more embodiments of the health and wellness system described herein can also assist users with managing their prescription medications. These aspects are now described with reference to FIG. 29. In this example, health and wellness system 2902 includes a user profile management component 2912 and context component 2914 (similar to user profile management component 2812 and context component 2818 of FIG. 28). As in previous examples, user profile management component 2912 creates and maintains user health profiles 2920 based on received medical record data 2904 and personal information 2906. Context component 2914 is configured to receive user context data 2908 relating to the user's current or predicted future environmental context (e.g., climate or weather conditions, time, day, etc.). User health profiles 2920 can include, as part of the user's medical data, prescription information identifying one or more medications currently prescribed to the user and a prescription schedule associated with each medication.

In this example, health and wellness system 2902 provides a centralized mechanism that helps users to manage their prescription schedules and to take their medications correctly. To this end, health and wellness system 2902 includes a prescription schedule management component 2922 that generates a prescription schedule 2924 based on prescription information stored in the user's health profile, and a notification component 2916 configured to generate prescription reminders 2910 based on the schedule. As with the wellness recommendations described above, prescription reminders 2910 can be delivered to one or more client devices associated with the user, which can be defined in the user's health profile (e.g., an email address, a phone number, etc.).

In one or more embodiments, user profile management component 2912 is configured to maintain current prescription information in respective user health profiles 2920. For example, user profile management component 2912 can receive medical record data 2904 (similar to medical record data 2804) containing information identifying a medication prescribed to a user by a physician, a schedule for taking the medication, instructions for how the medication should be taken or administered, or other information relating to correct usage of the medication. In some configurations, user profile management component 2912 can retrieve this medical record data 2904 directly from a database of medical records maintained by a medical facility. In such scenarios, user profile management component 2912 can extract the necessary prescription information and any other relevant medical information from the medical record data and update the user's health profile accordingly. Medical record data 2904 can also be provided directly to health and wellness system 2902 by the user's physician (e.g., through pre-designed interactive screens or secure web pages served to the physician's client device by the health and wellness system 2902).

Prescription schedule management component 2922 can read the prescription information for each user's health profile and generate a prescription schedule 2924 for each user of the system based in part on the prescription information. The prescription schedule 2924 defines, for each medication prescribed to the user, a schedule for taking the medication that is used to drive notification component 2916. Notification component 2916 can deliver prescription reminders 2910 to the user's client device at times defined by prescription schedule 2924. Prescription reminders 2910 can include information identifying the medication to be taken, and a time that the medication is to be taken. Prescription reminders 2910 may also include instructions for how to correctly take the medication (e.g., appropriate dosage, whether the medication should be taken on a full stomach, dosing instructions when administering the medication is complex in such cases where injectable and inhaler devices are required, etc.).

Notification component 2916 can issue the prescription reminders in accordance with one or more user preferences, which may be defined in the user's health profile or a separate user preferences profile. For example, health and wellness system 2902 may allow users to define how far in advance the prescription reminders 2910 are to be issued prior to the scheduled time at which the medication must be taken (e.g., 15 minutes in advance, one hour in advance, etc.). Users may also define the language (e.g., English, Spanish, etc.) and a format for the messages (e.g., email, text, automated voice, etc.) and destinations to which the reminders are to be sent (e.g., email addresses, phone numbers, identified client devices, etc.). In some embodiments, these preferences may be included in personal information 2906. Also, notification component 2916 may be configured to deliver an advanced notification to the user if certain preparations are required prior to taking the medication. For example, if the prescribed medication must be taken on a full or empty stomach, notification component 2916 can send an advanced notification one hour in advance of the medication reminder instructing the user to abstain from eating (or to eat).

Health and wellness system 2902 can also include a feedback component 2928 that receives user feedback 2930 in connection with the prescription reminders 2910. For example, when notification component 2916 issues a prescription reminder for a scheduled medication event, the notification component 2916 can begin awaiting confirmation from the user that the medication has been taken at the appropriate time. Feedback component 2928 can be configured to receive such confirmations from the user via the user's client device. In one or more embodiments, the prescription reminder can be rendered on the user's client device together with a confirmation softkey that, when activated, sends user feedback 2930 to the health and wellness system 2902 indicating that the medication has been taken and the pending notification can be dismissed. If the user feedback 2930 is not received within a defined time, notification component 2916 can continue to send subsequent prescription reminders 2910 at a defined frequency until confirmation has been received from the user. In one or more embodiments, health and wellness system 2902 may be configured to issue an alert to the user's physician or other specified person if user feedback 2930 is not received after a defined period of time. Such alerts can add a level of oversight to ensure that critical medications (e.g. heart medications, blood pressure medications, etc.) are being taken as indicated by the user's physician. A list of individuals to whom alerts are to be sent in the event of non-response to a prescription reminder (as well as destinations to which the alerts are to be sent) can be configured in the user's health profile or in a separate configuration profile associated with the user.

In one or more embodiments, prescription schedule management component 2922 can also dynamically adjust prescription schedule 2924 within reasonable limits based on contextual data or other extrinsic factors. Accordingly, context component 2914 (similar to context component 2818) can receive user context data 2908 relating to current or predicted environmental factors that may be relevant to the user's medication use. Prescription schedule management component 2922 can then adjust prescription schedule 2924 as needed in accordance with the identified environmental factors. For example, consider a scenario in which a user is currently on a regular schedule of asthma medication, and user context data 2908 indicates that a sudden drop in temperature is being forecast for the user's current location. It is known that such drops in temperature can sometimes trigger or elevate asthma attacks. Based on this information, prescription schedule management component 2922 may automatically adjust the prescription schedule 2924 to increase a dosage or frequency of the asthma medication for the time period corresponding to the expected drop in temperature. Depending upon the medical condition and types of medication the user is currently taking, prescription schedule management component 2922 may also modify the prescription schedule to add a supplemental medication to the user's existing schedule to mitigate the potential environmentally-triggered symptoms (e.g., supplementing a regular schedule of oral asthma medication with an inhaler during the time period that the environmental conditions are expected to elevate asthma symptoms). In this way, health and wellness system 2902 can assist the user to proactively prepare for changing environmental conditions that may lead to aggravated symptoms of an existing medical condition.

In a similar fashion, prescription schedule management component 2922 can downwardly adjust prescription schedule 2924 based on the user's environmental conditions. For example, a heavy rain often causes pollen levels in the air to be reduced, which can reduce the risk of allergic reactions for users having pollen-based allergies. Accordingly, if user context data 2908 indicates that a heavy rain is forecasted for the user's location, prescription schedule management component 2922 can suggest an adjustment in the prescription schedule 2924 to reduce a dosage or frequency of the user's allergy medication for a defined period of time after the scheduled rainfall.

It is understood that dynamic adjustment recommendations to a physician's prescription should only be made within acceptable limits to mitigate potential risks associated with improper medication. Accordingly, adjustments to prescription schedule 2924 can be made contingent on one or more safety checks built into health and wellness system 2902. For example, prescription schedule management component 2922 can access one or more medical databases 2926 (similar to medical databases 2822 of FIG. 28) to determine safe dosages of a given medication prior to adjusting the prescription schedule 2924. That is, if the user's current or anticipated environment indicates that an increased dosage or frequency of a given medication may be advisable, prescription schedule management component 2922 can access medical databases 2926 to determine an acceptable and safe dosage or frequency for the particular situation. Since proper dosage may depend in part on the user's physical characteristics, the database search can consider the user's height, weight, body mass index, or other physical traits in order to determine a safe adjustment to the prescription schedule 2924. Prescription schedule management component 2922 can also consider other medications the user is currently taking to ensure that any adjustments to the prescription schedule 2924 for a given medication do not conflict with the other medications. This determination can also be made based in part on a search of medical databases 2926.

As another safety precaution, one or more embodiments of health and wellness system can make context-based adjustments to prescription schedule 2924 contingent on approval from the user's physician. For example, if prescription schedule management component 2922 determines that environmental conditions at the user's current location may warrant an increase or decrease in an existing prescription schedule, health and wellness system 2902 may send a notification to the user's physician (identified in the user's health profile) indicating the proposed prescription schedule adjustment and requesting approval for the adjustment. As with prescription reminders 2910, health and wellness system 2902 can send such notifications to one or more designated email addresses, phone numbers, or personal devices specified in a user profile associated with the physician. The physician can respond to the notification with an approval or disapproval (e.g., by selecting a softkey rendered on the physician's personal device as part of the notification, by pressing an indicated number on a device's keypad, by responding with a vocal instruction, etc.). The physician's response is received at the health and wellness system 2902, and prescription schedule management component 2922 can proceed with the proposed schedule adjustment if the physician responds with an approval, or leave the prescription schedule unadjusted if the physician rejects the proposed adjustment.

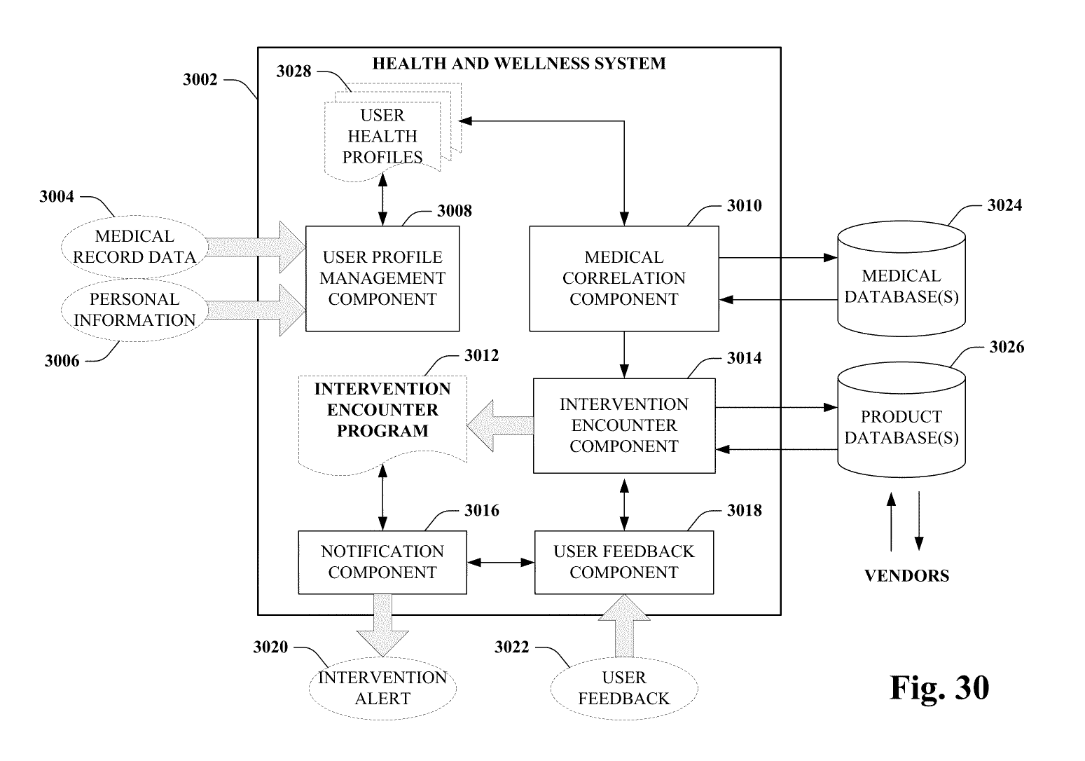

FIG. 30 illustrates another variation of the health and wellness system that provides interactive, proactive wellness guidance in accordance with each user's unique medical and physical conditions. As in previous examples, health and wellness system 3002 includes a user profile management component 3008 that maintains a set of user health profiles 3028 corresponding to respective users. User profile management component 3008 keeps the respective user health profiles 3028 current based on medical record data 3004 and/or personal information 3006 received for each user, as described in previous examples. Health and wellness system 3002 also includes a medical correlation component 3010 (similar to medical correlation component 2814) configured to access one or more medical databases 3024 containing medical knowledgebase information that can be leveraged in connection with providing beneficial and safe wellness recommendations.

In one or more embodiments, health and wellness system 3002 can assess a user's current health statistics, physical characteristics, prescriptions, or other personal information, identify potential future health issues the user is at risk of experiencing based on the user's personal information, and build a wellness program designed to reduce the user's predicted health risks. For example, a given user's health profile may indicate that the user suffers from high blood pressure, or that the user is currently taking blood pressure medication. The user's health profile may also indicate that the user's body mass index is high, and in particular is at a level that increases the user's risk of high blood pressure and associated health problems. This determination can be made by medical correlation component 3010 based on information available in the one or more medical databases 3024.

For example, medical correlation component 3010 can acquire information regarding the user's body mass index and blood pressure condition from the user's health profile, and access the one or more medical databases 3024 to determine whether there is a correlation between the user's current body mass index and blood pressure. Upon determining that the user's high blood pressure may be correlated with the user's recorded body mass index (and consequently that the user's body mass index may be a partial cause of the user's high blood pressure), medical correlation component 3010 can conclude that a program of weight loss may reduce the user's blood pressure and mitigate risks of future complications associated with high blood pressure (e.g., stroke). The medical correlation component 3010 may also determine a recommended amount of weight loss based on the user's current weight, height, body mass index, or other personal factors. In an exemplary scenario, medical correlation component 3010 may conclude that the user could safely reduce his or her weight by ten pounds over a recommended period of time, and that losing this weight has a high likelihood of lowering the user's blood pressure or reducing risks of related health issues.

Based on the correlations and determinations made by medical correlation component 3010, an intervention encounter component 3014 can generate an intervention encounter program 3012 designed to help the user achieve this weight loss goal. In one or more embodiments, intervention encounter component 3014 can initially set a recommended timeframe for the weight loss program (e.g., lose initial ten pounds in eight weeks) based on prevailing medical best practices and design a program to achieve this goal. However, this initial recommendation can be modified in accordance with user feedback, allowing the user a degree of control over the program, as will be described in more detail below.

Once the intervention encounter program 3012 has been generated, a notification component 3016 can deliver an intervention alert 3020 to a client device associated with the user (e.g., a client device, email address, phone number, or other notification destination defined in the user's health profile). This initial intervention alert 3020 can serve as a notification to the user that health and wellness system 3002 has identified a potentially beneficial wellness program based on the user's medical and personal information. The initial intervention alert 3020 can include a summary of the reasons for the alert (e.g., “Given your history of high blood pressure and your current weight, it has been determined that losing ten pounds may reduce your blood pressure and reduce your risk of related health issues”), and ask if the user is ready to begin following a wellness program designed to address the identified health issue (e.g., “Are you ready to achieve a healthy weight?”). The intervention alert 3020 can provide an option for responding to the alert in accordance with the particular client device and/or alert format (e.g., selecting a YES or NO softkey on a web page or other graphical display, pressing a particular numerical key on the device's keypad, vocally responding to an automated voice message, responding to a text massage, etc.).

The health and wellness system 3002 can allow the user a degree of control over the timing and level of commitment to the recommended wellness program. Accordingly, if the user is not ready to begin a weight loss regimen at the time the alert is received, the user may provide a NO response to the initial intervention alert 3020. This response can be received as user feedback 3022 at a user feedback component 3018. If a NO response is received, notification component 3016 can schedule a subsequent alert for a future time. The deferment time between receipt of a NO response and delivery of a subsequent intervention alert 3020 can be configured as a user preference and stored as part of the user's health profile or another profile associated with the user. The initial intervention alert 3020 can also include an option for opting out of the recommended intervention encounter program entirely. If such opt-out feedback is received, intervention encounter component will delete intervention encounter program 3012 and cease issuing intervention alerts for that particular program.

If the user does not opt out of the recommended intervention, but responds to the initial intervention alert with a NO (indicating that the user is interested but does not yet wish to begin the recommended intervention encounter program), subsequent reminder intervention alerts may include general information about the user's condition intended to educate the user and to encourage participation in the recommended intervention encounter program. For example, a subsequent intervention alert may include an informative message explaining the correlation between weight and blood pressure, possible impact on future health if the user's current weight is maintained, or other such information. In this way, health and wellness system 3002 attempts to increase the likelihood of a YES response from the user by educating the user on the potential benefits of taking proactive measures and the potential risks of ignoring the system's recommendations.

When the user responds affirmatively to the intervention alert 3020, notification component 3016 can begin a dialog with the user to customize the proposed intervention encounter program 3012 according to the user's preferences. For example, the system may provide the user with options for selecting a time frame for losing the recommended amount of weight (e.g., ten pounds in eight weeks, ten pounds in ten weeks, etc.), a preferred general strategy for losing the weight (e.g., dietary changes only, exercise only, a combination of diet and exercise, etc.), or other such options. The system can also allow the user to adjust the weight loss target (e.g., 15 pounds rather than 10 pounds).

Intervention encounter component 3014 can also incorporate product promotion into the intervention alert 3020. To this end, intervention encounter component 3014 can access one or more product databases 3026 (similar to product databases 2824) that maintains data relating to products, services, and discounts being offered by one or more vendors. In connection with assembling an intervention encounter program 3012, intervention encounter component 3014 can search the one or more product databases to identify products or services relevant to the intervention encounter program being generated. In the present weight loss example, intervention encounter component 3014 may determine, based on a search of the one or more product databases 3026, that a weight loss clinic located near the user is offering a reduced introductory membership fee, or that a seller of a dietary supplement or an appetite suppressant is offering a coupon for their product. Intervention encounter component 3014 can bundle an offer for these products or services in the intervention encounter program, and notify the user of these offers via the intervention alert. For example, the initial intervention alert 3020 alerting the user of the advisability of losing ten pounds and asking if the user is ready to begin a program of weight loss may also include a coupon for an appetite suppressant redeemable on the condition that the user agrees to begin the weight loss program. If the user agrees to the recommended intervention encounter program, the coupon can be delivered to the user through any suitable means (e.g., email, standard mail to the user's address, etc.).

In one or more embodiments, product data maintained in product database(s) 3026 can comprise product data from vendors who have entered into a strategic partnership with an administrator of health and wellness system 3002. In such embodiments, the administrator can grant selected vendors access rights to product database(s) 3026, allowing the selected vendors to enter information regarding products, services, and specials currently being offered. The one or more product databases 3026 can be configured to catalog this product data according to any appropriate cataloging schema to facilitate identifying appropriate products for a given type of intervention encounter. This can include tagging respective database records according to wellness topic, medical ailment, drug classification, or other relevant categories. Alternatively, product database(s) 3026 can comprise diverse extrinsic sources of product data maintained by third-party entities (e.g., merchant websites or databases). In such embodiments, health and wellness system 3002 can maintain a list of third-party data sources to be searched by intervention encounter component 3014 whenever an intervention encounter program 3012 is being generated.

After the intervention encounter program 3012 has been accepted and customized by the user, health and wellness system 3002 can continue to remotely guide the user through the selected intervention encounter program by maintaining an interactive dialog with the user. For example, consider a scenario in which the user has agreed to begin a program to lose ten pounds in eight weeks through a combination of dietary changes and exercise. Medical correlation component 3010 may determine a reasonable daily caloric intake for the user based on the weight loss goal and the user's current weight and general health (as determined from the user's health profile). Based on this daily caloric intake, intervention encounter component 3014 may provide daily meal recommendations to the user. These recommendations can be in the form of daily intervention alerts delivered to the user's client device. These daily alerts may also include coupons for food items that can be incorporated into the recommended dietary program. Such coupons can be retrieved from product databases 3026.

Intervention encounter component 3014 can also provide a recommendation for a daily exercise regimen. The recommended exercise regimen can be selected (e.g., by medical correlation component 3010) based on the user's weight loss goal and the user's current physical condition as determined by the user's health profile. For example, if the user's height, weight, and/or body mass index indicates that the user is considerably overweight, or if the user is of advanced age, medical correlation component 3010 may select a less rigorous daily exercise routine determined to be within the user's capabilities. Alternatively, if the user's age and/or physical capabilities are determined to be capable of more intensive physical activity, medical correlation component 3010 may design and recommend a more active or strenuous exercise program. Regardless of the type of exercise routine designed by the system, notification component 3016 can issue daily exercise reminders to the user's client device. These reminders can be issued each day at a time previously selected by the user (e.g., during the interactive dialog described above), and can include instructions for that day's routine (e.g., walk three miles, run one mile, etc.).

Intervention alerts instructing the user to perform an activity (e.g., the aforementioned daily exercise reminder, an instruction to take a particular medication, etc) can include a means for the user to provide confirmation feedback that the activity has been completed. User feedback may be collected from data entered on a web page or other graphical display, pressing particular numerical keys on the device's keypad, or directly from a remote device (e.g., pedometer, etc.). In the present weight loss example, user feedback 3022 can confirm that the day's exercise requirement has been completed. If such a confirmation is not received within a defined time frame, notification component 3016 can issue subsequent reminders until confirmation has been received. If no such confirmation is received by the end of the day, intervention encounter component 3014 may modify the present exercise program to make up the missing day by increasing the next day's exercise requirement (or the next several days' exercise requirements). Notification component 3016 may also periodically prompt the user to provide a current weight (e.g., each day, each week, etc.) to determine whether the user is on a trajectory to reach the defined weight loss goal. Based on the periodic weight data provided by the user, intervention encounter component 3014 may dynamically alter the exercise program to increase or decrease the daily exercise requirements based on the user's current rate of weight loss. For example, if the user's weight data at the two week point indicates that the user has only lost one pound, intervention encounter component 3014 may alter the recommended exercise program to increase the number of calories burned per day (e.g., by adding distance to the user's recommended daily walking routine, etc.), or alter the dietary recommendations to reduce the user's daily caloric intake.

Although health and wellness system 3002 has been described in terms of an exemplary weight loss recommendation triggered by a user's high blood pressure and current weight, it is to be appreciated that health and wellness system 3002 is not so limited. In particular, medical correlation component 3010 can be configured to identify a large range of proactive wellness measures (in addition to weight loss) based on a correlation of one or more of the user's current physical statistics, current medical issues, currently prescribed medications, and general medical knowledge gleaned from one or more medical databases 3024. For example, if the user's medical record indicates that the user suffers from depression, intervention encounter component 3014 may generate an intervention encounter program 3012 informing the user of the potential benefits of joining an interpersonal therapy group, and identifying registered therapy clinics at or near the user's current location. Notification component 3016 can then issue an intervention alert 3020 to the user that includes this information. The intervention alert 3020 can also prompt the user to indicate whether the user is ready to begin such therapy, whether the user wishes to defer such a program, or whether the user wishes to opt out of future intervention alerts relating to this medical issue. When the user indicates readiness to begin interpersonal therapy (e.g., via user feedback 3022), health and wellness system 3002 can prompt the user to select a clinic or service provider from the list of local and online recommendations, and facilitate connecting the user with the selected service provided (e.g., by directing the user to the provider's web site, initiating a phone call between the user's client device and the selected service provider, etc.). As in the weight loss example described above, intervention alerts 3020 can include relevant, vendor-specific incentives in the form of discounts offered by service providers. Such discounts can be identified and retrieved from product database(s) 3026 by intervention encounter component 3014. Similar techniques can be used to identify a broad range of proactive wellness interventions relating to virtually any type of medical concern, where such interventions are tailored to the individual's unique personal and medical situation.

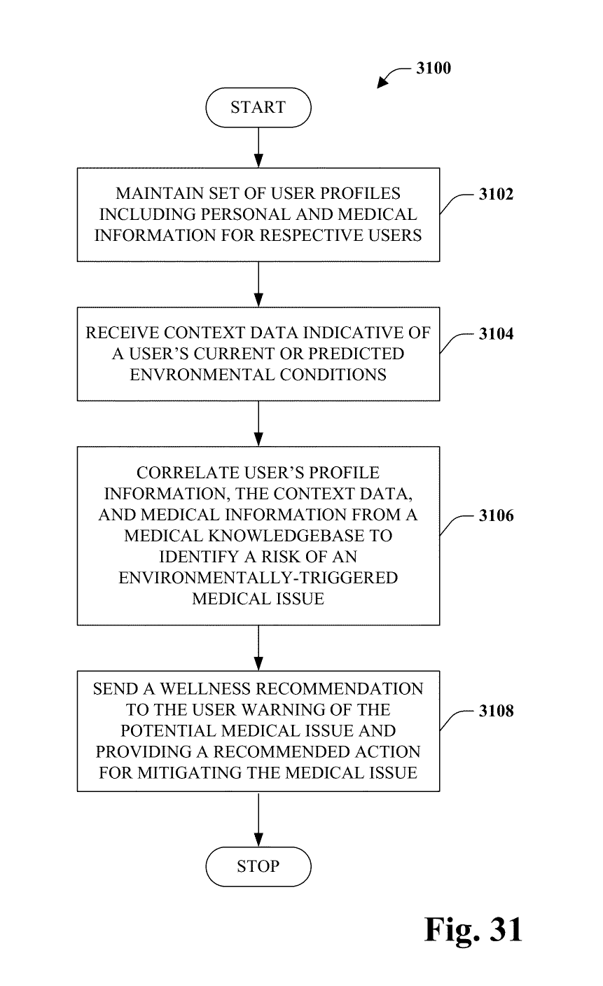

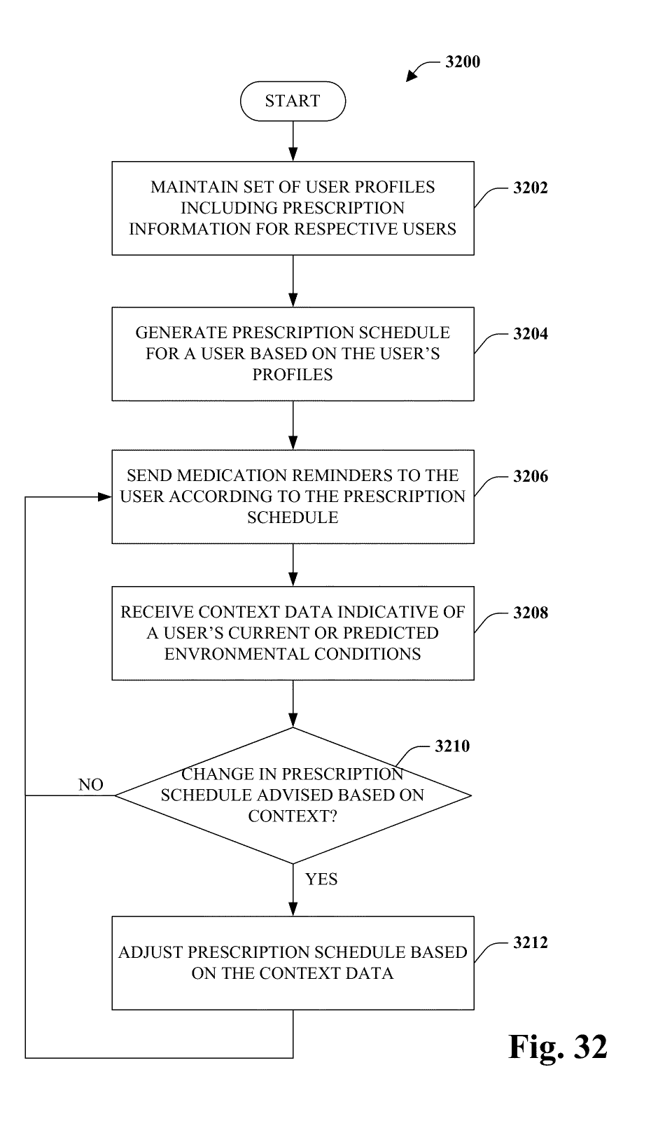

FIGS. 31-32 illustrate various methodologies in accordance with one or more embodiments of the subject application. While, for purposes of simplicity of explanation, the one or more methodologies shown herein are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation. Furthermore, interaction diagram(s) may represent methodologies, or methods, in accordance with the subject disclosure when disparate entities enact disparate portions of the methodologies. Further yet, two or more of the disclosed example methods can be implemented in combination with each other, to accomplish one or more features or advantages described herein.

FIG. 31 illustrates an example methodology 3100 for providing context-specific wellness recommendations to users with existing medical conditions. Initially, at 3102, a set of user profiles are maintained that include personal and medical information for respective users. Such profiles can include such personal data as the user's identification, height, weight, body mass index, residential address, preferences, and other such personal data. User profiles can also include relevant medical information for the user, including but not limited to existing medical conditions, last recorded or average health statistics (e.g., blood pressure, blood sugar, cholesterol level, etc.), or other medical information. This medical information can be retrieved from a physician's patient database, provided manually by the user or the user's physician, or by any other suitable means.

At 3104, context data indicative of the user's current or predicted environmental conditions is received. This context data can include, for example, the user's current location, temperature, humidity, ozone level, pollen count, barometric pressure, rainfall, or other environmental information. This context data can be received from any suitable information source, including but not limited to a GPS system, weather tracking systems or forecasting websites, metering devices carried by the user, or other such data sources.

At 3106, the user's profile information and the context data are correlated with medical information from a medical knowledgebase to identify a risk of an environmentally-triggered medical issue. For example, if the user's medical information indicates that the user suffers from a medical condition having symptoms that may worsen in certain environmental conditions (e.g., high temperature or humidity, high barometric pressure, etc.), correlation of this medical information with the current or predicted context information and medical information maintained in the medical knowledgebase can yield a determination that the current or future climate at the user's current location is likely to aggravate the user's symptoms. At 3108, a wellness recommendation is sent to the user warning of the potential medical issue and providing a recommended action for mitigating the medical issue. Exemplary wellness recommendations can include, but are not limited to, increasing or supplementing a current schedule of medication, remaining indoors as much as possible, apply sunblocking lotion or pain relief ointment prior to venturing outdoors, or other such recommendations. In one or more embodiments, steps 3102-3108 can be performed by a centralized health and wellness system that services multiple users, and the wellness recommendation of step 3108 can be issued to a client device, email address, phone number, etc. associated with the user.

FIG. 32 illustrates an example methodology 3200 for assisting a user to manage a medication prescription. Initially, at 3202, a set of user profiles are maintained that include prescription information for respective users. In some embodiments, the user profiles can be generated and dynamically updated based on medical records retrieved from respective physician databases. Alternatively, the profiles can be maintained manually by the user or the user's physician. At 3204, a prescription schedule is generated for a user based on the prescription information in the user's profile. The schedule can include an identification of the medication the user is taking, a prescribed dosage, a frequency with which the user is to take the prescribed dosage, and any additional instructions for taking the medication.

At 3206, medication reminders are sent to the user based on the prescriptions schedule generated at step 3204. These reminders can be sent to one or more preferred destinations pre-configured by the user, including but not limited to a particular mobile device, an email address, a phone number for text-based or automatic voice reminders, etc. The medication reminders can indicate the medication to be taken, the correct dosage, and/or any other relevant instructions for proper usage of the prescribed medication (e.g., an indication that the medication must be taken on a full or empty stomach, etc.). In some scenarios, the medication reminders can be sent in advance of the actual time that the medication is to be taken. Advanced notifications may be required, for example, if the user is to take the medication on an empty stomach. In such scenarios, a preliminary reminder can be sent instructing the user to abstain from eating for the next hour, and a subsequent notification can be sent an hour later reminding the user to take the scheduled medication.

At 3208, context data indicative of the user's current or predicted environmental conditions is received. At 3210, a determination is made regarding whether a change to the prescription schedule is advised based on the environmental factors indicated by the context data. For example, if the prescribed medication is an allergy medication, and the context data indicates that environmental conditions known to aggravate symptoms of the user's allergies are in effect at the user's location, it may be decided that a recommendation of an increase in the prescribed dosage (or frequency) of allergy medication would safely reduce the risk of elevated symptoms. The prescription schedule may also be downwardly adjusted if environmental factors suggest that the user is at a lower than normal risk of climate-triggered allergic reactions. In some embodiments, any potential adjustments to the prescription schedule can be made contingent on approval of the user's physician. Accordingly, an electronic notification can be sent to the user's physician providing information regarding the recommended prescription adjustment, and the adjustment will only be made in response to a confirmation response from the physician.

If it is decided at 3210 that no change to the prescription schedule is required, the methodology returns to step 3206 to continue sending the medication reminders according to the original prescription schedule. Alternatively, if it is decided at 3210 that a change to the prescription schedule is advised, the methodology moves to step 3212, where the prescription schedule is adjusted based on the context data. The methodology then returns to step 3206, where the medication reminders continue to be sent based on the modified schedule.

As used herein, the terms “component,” “system” and the like are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated that a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject innovation.

Herein, the term “advertisement” is meant to refer to any form of communication seeks to attract attention to a merchant or one or more products or services of a merchant. For example, an advertisement can be a marketing message of arbitrary complexity designed to persuade customers to make a purchase. In one particular instance, an advertisement can include or correspond to a promotional offer. For example, a coupon offering a discount on a purchase from a merchant is an advertisement.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

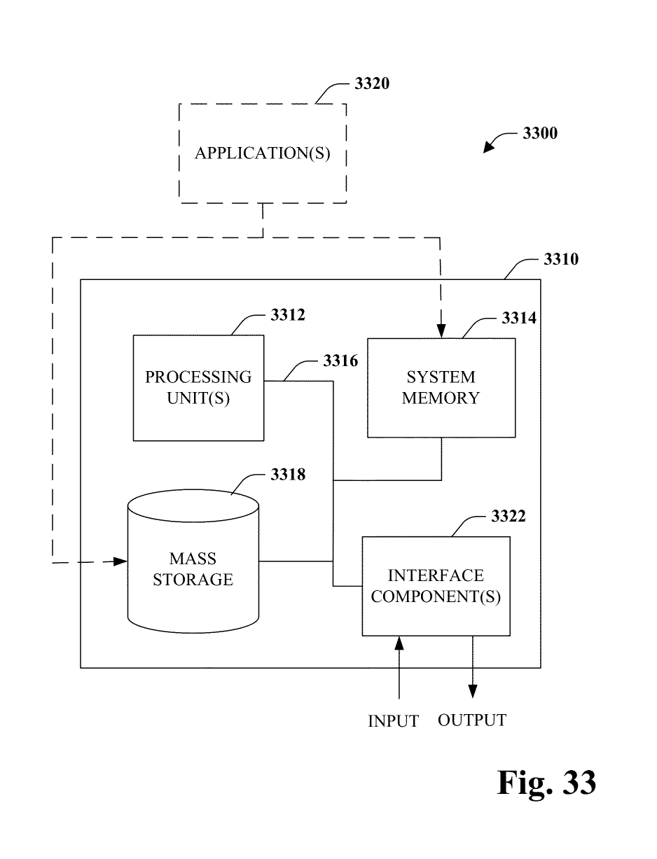

In order to provide a context for the various aspects of the disclosed subject matter, FIGS. 33-35 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 33, an exemplary environment 3300 for implementing various aspects disclosed herein includes a computer 3310 (e.g., desktop, laptop, server, hand held, programmable consumer or industrial electronics . . . ). The computer 3310 includes a processing unit 3312, a system memory 3314, and a system bus 3316. The system bus 3316 communicatively couples system components including, but not limited to, the system memory 3314 to the processing unit 3312. The processing unit 3312 can be any of various available microprocessors. It is to be appreciated that dual microprocessors, multi-core and other multiprocessor architectures can be employed as the processing unit 3312.

The system memory 3314 includes volatile and nonvolatile memory. Volatile memory includes random access memory (RAM), which can act as external cache memory to facilitate processing, among other things. Nonvolatile memory can include, without limitation, read only memory (ROM). For example, the basic input/output system (BIOS), includes basic routines to transfer information between elements within the computer 3310, such as during start-up, is stored in nonvolatile memory.

Computer 3310 also comprises mass storage device(s) 3318 of various types such as removable/non-removable and/or volatile/non-volatile for housing data. Mass storage 3318 includes, but is not limited to, devices like a magnetic or optical disk drive, floppy disk drive, flash memory, or memory stick. In addition, mass storage 3318 can include storage media separately or in combination with other storage media. By way of example and not limitation, mass storage 3318 can correspond to either or both of an internal computer store and removable store.

FIG. 33 provides software application(s) 3320 that act as an intermediary between users and/or other computers and the basic computer resources described in the suitable operating environment 3300. Such software application(s) 3320 include one or both of system and application software. System software can include an operating system, which can be stored on mass storage 3318, that acts to control and allocate resources of the computer 3310. Application software takes advantage of the management of resources by system software through program modules and data stored on either or both of system memory 3314 and mass storage 3318. Accordingly, applications 3320 transform a general-purpose machine into a specific machine that executes particular functionality in accordance with one or more applications 3320.

The computer 3310 also includes one or more interface components 3322 that are communicatively coupled to the bus 3316 and facilitate interaction with the computer 3310. By way of example and not limitation, the interface component 3326 can be a port (e.g., serial, parallel, PCMCIA, USB, FireWire . . . ) or an interface card (e.g., sound, video, network . . . ) or the like. The interface component 3322 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer, and the like. Output can also be supplied by the computer 3310 to output device(s) via interface component(s) 3322. Output devices can include displays (e.g., CRT, LCD, plasma . . . ), speakers, printers, and other computers, among other things.

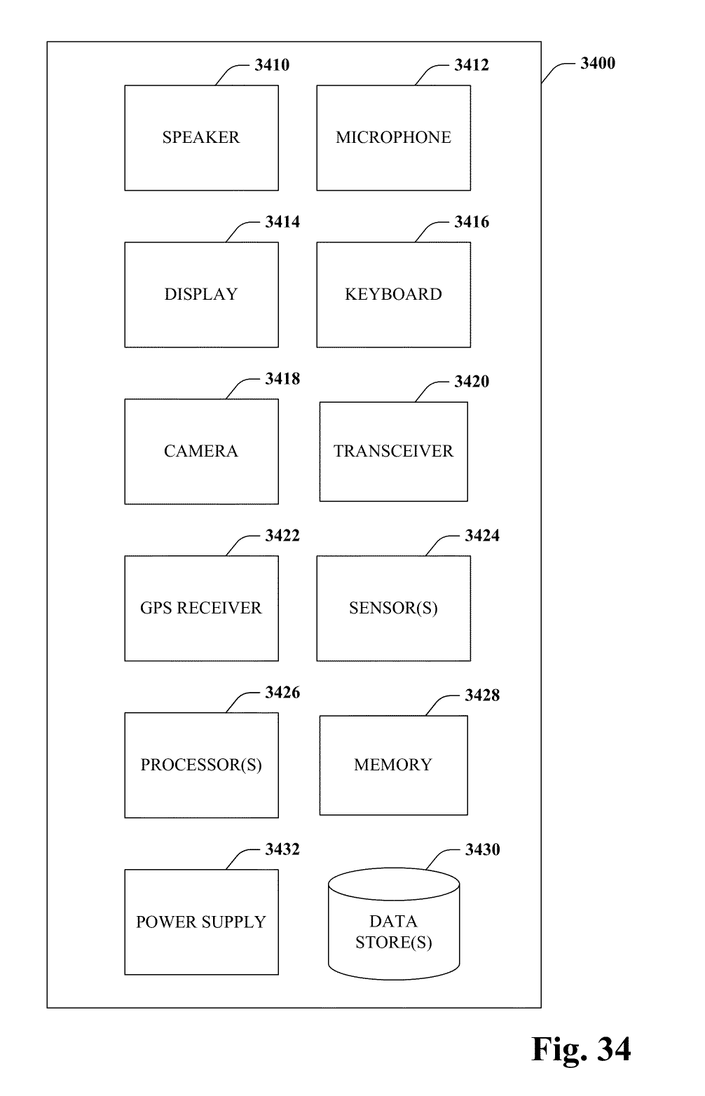

Turning attention to FIG. 34, an exemplary mobile computing device 3400 is shown that can provide a suitable operating environment of at least a portion of claimed aspects. As illustrated, the device 3400 includes at least one speaker 3410 and microphone 3412 for producing and recording audio, respectively. Display 3414 provisions a visual representation of data and information to a user of the device 3400 to facilitate use. In one aspect, the display can be touch-sensitive to enable device functionality to be accessed by touch. Of course, the device is not limited thereto and other means of access or interaction can be provided alone or in combination. For instance, the device 3400 can include a keyboard 3416 to input data and navigate device functionality. Other input mechanism are also possible but not shown include a mouse or trackball, among other things. The device 3400 can also include a camera 3418 to allow capture of pictures and/or video. The camera 3418 can also be associated with a light source to facilitate recording in low light situations.

Transceiver 3420 is a mechanism that enables communication of the device 3400 with other like or disparate devices, access points, and/or networks, among other things. The transceiver 3420 includes functionality for both transmitting and receiving wireless signals. Consequently, the transceiver 3420 can include, or be communicatively coupled to, one or more internal and/or external antennas (not shown). For example, the transceiver can enable voice communication over one or more telephone networks and/or data transmission (e.g., Bluetooth, Wi-Fi, WiMax . . . ).

The mobile computing device 3400 can also include a GPS (Global Positioning System) receiver 3422. The GPS receiver 3422 is able to locate and receive information from a plurality of orbiting satellites. From acquired information, the GPS receiver 3422 is able to compute its location, which can then be employed by the device 3400 or applications executing thereon to provide location dependent functionality (e.g., navigation). Additionally or alternatively, it should be appreciated that cellular transmissions can provide information as a function of signal strength and employment of one or more cell towers, for instance. Other location means or mechanisms are also possible including those associated with proximity and network access (e.g., IP address), among other things.

The device 3400 can also include one or more sensors 3424 for acquiring information pertaining to the device itself or its surroundings. For example, an accelerometer and/or gyroscope can be incorporated into a device to sense movement of the device. This information can then be utilized to aid device interaction. Other sensors 3424 are also possible including, inter alia, an altimeter for measuring altitude or height above a fixed level, a thermometer for quantifying temperature, a barometer for measuring pressure, a hygrometer for sensing humidity, an optical sensor for detecting light, a microphone for sensing sound, a smell sensor for identifying scents, and a proximity sensor for measuring distance from an object or entity.

The computing device 3400 also includes one or more processors 3426, memory 3428, one or more data stores 3430, and a power supply 3432. The processor(s) 3426 executes instructions local to the processor and/or housed in memory 3428 to perform some functionality dictated by a hardware and/or software program. The memory 3428 provides volatile and non-volatile storage of data and instructions for expeditious access by the processor(s) 3426. Data store(s) 3430 is a mechanism for persisting large amounts of data and instructions for later use. For example, the device can have an internal data store as well as mechanism to utilize a removable storage device such as a flash memory card or the like. Finally, the device 3400 can include a power supply to enable operation of its component such as but not limited to a rechargeable battery.

It should be appreciated components of the mobile device 3400 are merely exemplary and can vary as a function a mobile device type or configuration, among other things. For example, the mobile device can correspond to a mobile phone in one embodiment. However, the device can also be a personal digital assistant (PDA), electronic book reader, or a gaming system, which necessitate addition of components, removal of components and/or reconfiguration of components.

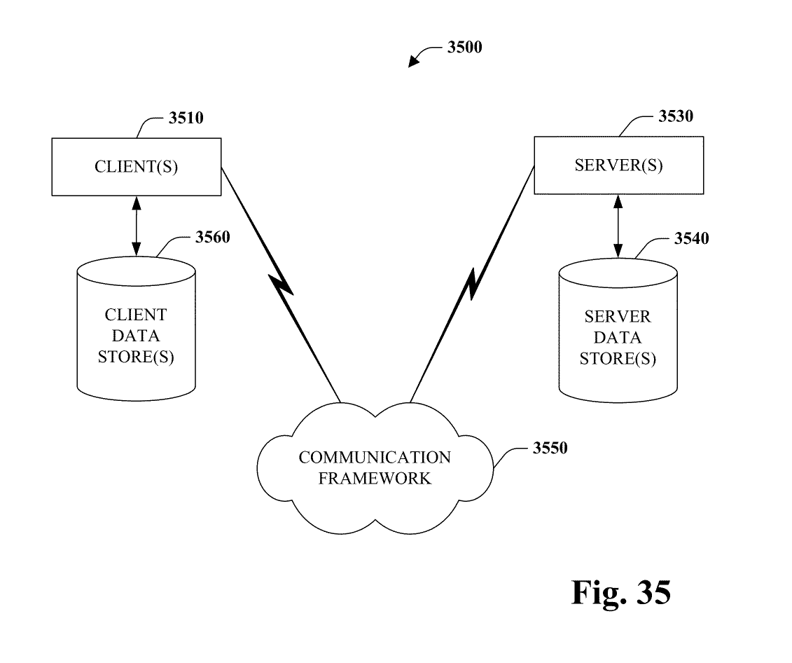

FIG. 35 is a schematic block diagram of a sample computing environment 3500 with which the subject innovation can interact. The sample computing environment 3500 includes one or more client(s) 3510. The client(s) 3510 can be hardware and/or software (e.g., threads, processes, computing devices). The sample computing environment 3500 also includes one or more server(s) 3530. Thus, sample computing environment 3500 can correspond to a two-tier client server model or a multi-tier model (e.g., client, middle tier server, data server), amongst other models. The server(s) 3530 can also be hardware and/or software (e.g., threads, processes, computing devices). The servers 3530 can house threads to perform transformations by employing the aspects of the subject innovation, for example. One possible communication between a client 3510 and a server 3530 may be in the form of a data packet transmitted between two or more computer processes.

The sample computing environment 3500 includes a communication framework 3550 that can be employed to facilitate communications between the client(s) 3510 and the server(s) 3530. The framework 3550 can include one or more of many wired and/or wireless communication means including without limitation the Internet and cellular technologies, among others. The client(s) 3510 are operatively connected to one or more client data store(s) 3560 that can be employed to store information local to the client(s) 3510. Similarly, the server(s) 3530 are operatively connected to one or more server data store(s) 3540 that can be employed to store information local to the servers 3530.

Client/server interactions can be utilized with respect with respect to various aspects of the claimed subject matter. By way of example and not limitation, the client(s) 3510 can correspond to a user computer or mobile device such as a phone, which is able to communicate with a mobile marketing system or at least a subset of such functionality executed by one or more servers 3530 across the communication framework 3550. Further, the server(s) 3530 can afford a mobile application comprising mobile marketing functionality that can be downloaded over the communication framework 3550 and subsequently installed by the client(s) 3510. Further yet, all or portions of the mobile marketing system can be hosted by one or more servers 3530 and accessible via one or more clients 3510 including mobile and other computer devices to facilitate input consumer and advertiser information (e.g., profiles, preferences, setting . . . ), for example through an online website.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims. Furthermore, to the extent that the terms “includes,” “contains,” “has,” “having,” or variations in form thereof are used in either the detailed description or the claims, such terms are intended to be inclusive in a manner similar to the term “comprising” as “comprising” is interpreted when employed as a transitional word in a claim.

What is claimed is:

1. A system for providing health and wellness recommendations, comprising:
a memory;
a processor that executes computer-executable components stored in the memory to implement the system, the computer-executable components comprising:
a user profile management component configured to create and update a user health profile containing personal and medical information;
a medical correlation component configured to generate a wellness recommendation based on the personal and medical information; and
a notification component configured to send a notification that includes the wellness recommendation to a specified destination.

2. The system of claim 1, wherein the medical correlation component is further configured identify a correlation between a medical condition specified by the user health profile with one or more physical characteristics specified in the user health profile, and to generate the at least one wellness recommendation based on the correlation.

3. The system of claim 1, wherein the medical correlation component is further configured to generate the wellness recommendation based on information retrieved from a medical knowledgebase.

4. The system of claim 1, further comprising a context component configured to receive context data relating to one or more current or predicted environmental factors at a user location, wherein the medical correlation component is further configured to generate the wellness recommendation based in part on the context data.

5. The system of claim 1, wherein the specified destination is at least one of a mobile device, an email address, or a phone number.

6. The system of claim 4, further comprising:
a prescription schedule management component configured to generate a prescription notification schedule based on prescription information stored in the user health profile,
wherein the notification component further configured to send prescription reminders to one or more client devices based on the prescription notification schedule.

7. The system of claim 6, wherein the prescription schedule management component is further configured to adjust the prescription notification schedule based in part on the context data.

8. The system of claim 1, wherein the notification component is further configured to include, in the notification, an offer for a product or service determined to be relevant to the wellness recommendation.

9. The system of claim 1, further comprising an intervention encounter component configured to generate an intervention encounter program designed to address one or more health issues identified by the medical correlation component.

10. The system of claim 9, wherein the notification component is further configured to send a notification to the specified destination that the intervention encounter program is available, and to provide interactive health recommendations in accordance with the intervention encounter program.

11. A method for issuing health recommendations, comprising:
reading personal and medical information from a user health profile;
generating a wellness recommendation based on the personal and medical information; and
sending the wellness notification as a notification to a specified destination.

12. The method of claim 11, wherein the generating the wellness recommendation comprises correlating a medical condition identified in the user health profile with one or more physical characteristics identified in the user health profile and generating the wellness recommendation based at least in part on the correlating.

13. The method of claim 11, wherein the generating the wellness recommendation comprises accessing medical information stored in a medical knowledgebase and generating the wellness recommendation based at least in part on the medical information.

14. The method of claim 11, wherein the generating the wellness recommendation comprises generating the wellness recommendation based at least in part on context data indicative of one or more current or forecasted environmental conditions at a user location.

15. The method of claim 11, wherein the sending the wellness recommendation comprises sending the wellness recommendation to at least one of a specified mobile device, an email address, or a phone number.

16. The method of claim 14, further comprising:
generating a prescription notification schedule based on prescription information stored in the user health profile; and
sending at least one prescription reminder to the specified destination in accordance with the prescription notification schedule.

17. The method of claim 16, further comprising adjusting the prescription notification schedule based at least in part on the context data.

18. A computer-readable medium having stored thereon computer-executable instructions that, in response to execution, cause a computing system to perform operations, the operations including:
creating a user health profile that stores personal and medical information for a user;
generating a wellness recommendation for the user based on the personal and medical information; and
sending a notification that includes information regarding the wellness recommendation to a specified destination.

19. The computer-readable medium of claim 18, wherein the generating the wellness recommendation includes:
identifying a correlation between a medical condition identified in the user health profile and one or more physical traits identified in the user health profile; and
generating the wellness recommendation based at least in part on the correlation.

20. The computer-readable medium of claim 18, wherein the generating the wellness recommendation includes generating the wellness recommendation based in part on context data indicating a current or predicted environmental condition at the user's current location.
